(19) United States
(12) Patent Application Publication
(10) Pub. No.: US 2024/0211870 A1
(43) Pub. Date: Jun. 27, 2024

(54) WEB-BASED INVENTORY MANAGEMENT SYSTEM AND METHOD

(71) Applicant: Michael Bloom, London (GB)

(72) Inventor: Michael Bloom, London (GB)

(21) Appl. No.: 18/087,905

(22) Filed: Dec. 23, 2022

(51) Int. Cl. G06Q 10/087; G06F 16/958

(52) U.S. Cl. CPC G06Q 10/087; G06F 16/958

(57) ABSTRACT

A locally based or web-based inventory management system is disclosed. The web-based inventory management system comprises a computing device having a processor coupled to a memory, and communicatively coupled to a server over a network interface. The computing device having a stock management interface (SMIs) for providing fast or near instant responses to any update, data selection, filter or data configuration the user requires and configured with a single screen interface that is standard across all appropriate stock management functions and data types. Further, a database is configured to store data related to activities of a supply chain management environment. The database comprises program modules to handle one or more stock-keeping units (SKUs) per product with respect to the one or more activities and enable navigation in the single screen interface while providing the user at any time with granular product data in any of at least three formats.

### FIELD OF THE DISCLOSURE

The present invention relates to systems and methods for managing products, and more particularly, relates to a locally based or web-based inventory management system to present multiple inventory data over a common interface.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to management of products or inventories on a locally or web-based platform, wherein such a platform may also correspond to implementations of the claimed technology and invention.

Stock management systems generally provide an end-to-end solution for tracking and analysing components, finished stock, sales, purchase and sales orders, customers, and all other aspects related to managing stock/inventory. The stock management system or inventory control system or stock control system or supply chain management system or enterprise resource planning system is used to assist any organisation requiring the tracking of stock, such as a retail or wholesale or warehousing or manufacturing business incorporating a central hub with links for data synchronisation and distribution to satellite devices/apps such as tills, web sites, hand held devices and third parties, for example external marketplace web sites, web site platforms, handheld and mobile devices, courier systems, credit card processing apps and desktop and/or online accounting systems. It may also be used for tasks incorporating stock control within a larger enterprise where uniforms and other supplies are required, such as an army or hospital/health care system. Further, the stock management system provides an option for any organisation that handles stock and goods of multiple types or data sets for various products, to manage and regularly sell, transfer or otherwise alter stock and goods at multiple locations/channels to allow an organisation to run smoothly—e.g., ubiquitously track the movement, whereabouts and status of components, stock and goods. However, the management of such large data sets, with accuracy, is impractical for human as these multiple data sets are altered continuously and often outside of the immediate purview of a person. Further, the conventional representation of these data sets is highly fragmented and not efficiently portrayed over a computer screen, which makes it difficult for a person to understand the complete picture. Conventional stock management systems store and represent every stock keeping unit (SKU i.e. the most granular level of a product's classification, say a product by a unique combination of size and colour) as a completely separate item, isolated from every other SKU. As a direct consequence of this, the way products are displayed on a screen is generally as a separate line for each SKU (the line may contain a product name, stock value, selling price, plus a size, a colour and a fit if appropriate etc.). Within these systems there is only one system-wide way to interactively see stock/sales/order data etc. and that's as a completely granular line by line level (i.e. one individual SKU at a time, on a separate line across the screen). Where products have multiple variants of the same product (e.g. mobile phones, homeware, chocolate bars, bedding, clothing, footwear etc.) there is often no divide or totals between the individual lines for one product and the individual lines for the next product—the list just goes on and on across hundreds of screens. SKU's in the real world however are not isolated. A single wristwatch in red may also come in blue (i.e. a second, but linked, SKU). A small pottery mug or small chocolate bar may also come in medium and large. Some items, such as clothing and footwear, come in both many sizes and many colours. For these types of products linking multiple SKU's into an overall product, at every point across an entire system (and not just as an occasional screen or report) is a tremendous advantage for input and for reporting output e.g., entering stock into a blank matrix grid linking a products SKU's, with colours down the side (the y axis) and sizes along the top (the x axis), vastly speeds up inputting. When the same matrix format is populated with stock, sales, order information etc., it is far quicker to access as well as easier and faster for a human to comprehend the product overall, when compared to a series of individual SKU data lines running down one or multiple computer screens.

Further, stock management systems are currently function/module orientated and consequently present a user with numerous different screens, each of which generally and usually performs a limited range of functions or just a single function. As an adverse impact, most user tasks for managing stock/inventory and the like require that within a module a user navigates via the menu system to access multiple different screens in a sequence of steps to achieve an end goal. Adversely, each sequence has to be learned/pieced together by the user and each function-oriented screen or reporting interface may be significantly different from other function-oriented/reporting screens. Certainly, data types in conventionally systems make a considerable difference to user interaction with the system; the user operation of the stock module will differ to that of the sales or transactions module which will differ to that of the customer module Likewise, to complete a task, the user is also required to frequently move out of one module to another, and then back again, in order to achieve an end goal or to access different types of data. For example, a stock module in a stock management system may provide an interface, functions and reports for all things related to stock, but this may be separate and different to a sales module, which is exclusively used for all things related to sales. Likewise, the same division of stock management interface, function and reporting is often true for modules related to purchase orders, general reporting, barcode production, etc. In practice, this means that a real-world tasking of/by a user for the operation of a stock management system is progressed and/or accomplished by moving from one relatively rigid functional area (e.g., via a computerized stock management system screen) to another functional area of the stock management system using a menu to navigate, before perhaps having to return to an area they previously left. Further, even within a module, frequent movement between different and inconsistent screens is also required. In a business with multiple locations/sales channels and thousands of SKU's all of which are moving in, out and between locations and status's (e.g. sold, transferred, on hold, return to supplier etc.), constant navigational screen-hopping, via an extensive menu system, is a natural consequence of the functional approach, where only a very limited task or limited search for information can be done within any one screen. For example, in the process of receiving into stock new single-variant products or multi-variant products (e.g. a product with multiple sizes, colours and fits etc.), a user currently needs to undertake a series of navigation tasks between modules and within modules. The consequence of this overall fragmentation is that each stage/task can take a long time to perform, the user does not develop an intuitive understanding of the wider business picture, and there is ample opportunity for confusion—and clearly, the more stages a user is expected to piece together the more room there also is for error. As an example of the conventional stages required, to receive in new single-variant products or multi-variant products, such as clothing with colour and/or multiple dimensions (e.g. colour, size, fit, location), a user may need to undertake a series of navigation tasks. First, the user navigates to the product creation area of the system and then creates the product (depending upon the system they may have to replicate this menu navigation multiple times if it's a multi-variant product). Then the user may need to move to a separate area, locate the newly created product and enter the product's stock (again, they may have to replicate this menu navigation multiple times if it's a multi-variant product); after this the user may then need to navigate to a separate barcode label production area where they may need to once again locate the newly created product before producing barcode labels (usually per SKU, so multiple times). To report on the new product's status (e.g., overall stock quantity and value) they would then need to go to their separate reporting module, complete a filter and run a report. If later they want more information on the products stock, and sales, and orders they may have to loop through one or more reports, or even via completely separate stock, sales and orders reporting modules, multiple times.

The consequence is that standard tasks are usually made up of many complex and complicated stages and take longer to perform. Constant navigational screen-hopping is the natural consequence of the functional approach, where only a very limited task or limited search for information can be done within any one conventional stock management or supply chain management screen. So, managing and tracking each and any conventional/real-world business process task requires a user to move to multiple, inconsistent, separate areas (and screens) of the stock management system. Consequently, for users, there is more room for confusion between the many stages and nobody can truly grasp the overall business picture. Further, what knowledge there is becomes limited to only a few individuals, each with different expertise—since tasks are excessively time consuming and some people in an organization may be good at using one functional area but struggle to comprehend and timely perform dynamic tasks in other areas. Herein, conventional stock management concentrates on stocks, sales and placing orders to suppliers taking into account supplier parameters such as leads times or tariffs plus customer data and supply chain management is to manage data flows and inventory taking into account all sort of capacity and productivity issues along the way plus all the financial costs/benefit implications of each stage. Stock management, with external third party links plus customer tracking and loyalty, is a critical element of the supply chain, because it involves the tracking of inventory from manufacturers to warehouses and from these facilities to a point of sale and beyond. The goal of inventory management is to have the right products in the right place at the right time and to provide a reporting framework that supports this.

As a further example of traditional systems fragmentation, the order receipt process typically involves: finding the screen to review goods on order and maybe navigating the menu system to a different screen to enter (i.e. receive) goods arriving, navigating menus to another screen to review goods in a holding area, navigating menus to a different screen for barcode labelling, and then finding yet another screen to input the transfer of these goods from the warehouse to various shops, etc., while also seeking separate decision supporting information from the system reporting menu(s). The time involved in menu navigation alone would be extensive, and error prone, overall taking anything from 20-60 navigational clicks. Further, each of the operational tasks is usually made in complete isolation from the systems reporting function. For example, users often enter transfer data ‘blind’, in that the systems transfer screen lets them type in the stock numbers the user wishes to transfer, but gives them limited or no decision supporting contextual information on the current stock of the product being held at the two or more locations involved, and/or recent sales from each location, and/or sell-through rates at the locations, etc. For a user, this supporting data would need to be gleaned from a range of time consuming, pre-printed, reports.

Detailed reporting is itself a further example of the traditional separation of functions; as a minimum reporting is always at least one separate module to everything else. The effect of this is to separate the users' day to day input interaction with their system(s), from all or most of the information the user needs to make informed interactive decisions. For example, if the user wishes to evaluate and re-price a range of products, the user would first need to open a reporting module to physically print out, in advance, the decision supporting information the user thinks they will need, e.g. a best seller's performance report and also perhaps a separate current stock holding report; different users will want a combination of different information. If the user wants to look at a number of individually selected poor performing products, then the user may need to re-filter the same report(s) numerous times to ensure all the products the user needs are included and/or to make sure they know where the relevant products are within the voluminous printouts. If the user also needs to print a report detailing ‘goods outstanding on order’ for those same products, then the user might need to open a third type of report and then filter that data for the products they needed.

Just creating the correctly filtered reports can take a lot of time, but even with the printouts in front of them the user still needs to find the same product in each of the two or three physical printouts. It is only when users have located the same product on the screen and also on each of multiple reports that the user is actually able to make an informed judgment as to setting a new price. When users have done this for each product, one product at a time, they might then need to navigate to another part of their system in order to print/email a new price list and then navigate to yet another area to re-print barcode labels for each of the newly re-priced items. In practice, the process is so complicated and time consuming that relatively few retailers (or wholesalers or manufacturers etc.) actually undertake the process. Where they do undertake the aforementioned process there is a significant cost in time and personnel (e.g., users) salaries. On the other hand, where system users don't undertake the process, there is a large, but often “invisible”, cost in poor decision making and a loss of business inefficiency/profitability. This invisible cost is generally accepted by all businesses and not calculated or fully considered because it's just “the cost of doing business” and no superior alternative has been available.

Prior art, for various aspects contained there within, relevant to this disclosure includes U.S. Pat. No. 9,443,247B2 to Yu-feng Gu, U.S. Pat. No. 20150073955A1 to Jonathan A. Gilman, U.S. Pat. No. 20060195370 to Howarth Christopher, and U.S. Pat. No. 20190005573 assigned to Hornsby Nathan. In each of these prior art references, a method and system for inventory management that includes collecting sales information is described. Further, in one or more of the aforementioned references, a method of generating an inventory management interface in a web-browser and maintaining a stock database, including counts of inventory of multiple items, is described, respectively. In each of these systems there is a requirement for multiple screens for providing accessibility to data leaving open the need to reduce confusion associated with current stock management systems and tools. In this respect, one object of the present invention disclosure is to provide a solution, the integration of multiple data types and tasks within a single screen structure.

In particular, the reference '247 to Yu feng Gu discloses a dashboard application that may enable a user to quickly view data (and, in a particular aspect, data from one or more business applications) in an efficient manner. The dashboard application may be used to view data about one or more metrics that reflect the performance of a business, as derived from data maintained (perhaps in an associated data store) by the business application(s). In an aspect, a user may select two or more metrics to be displayed on a summary page and/or may invoke a detail page to view detailed information about one of the two or more metrics. However, unlike the subject matter of the disclosed invention, Yu feng Gu discloses the system that can only represent summary data over a single screen view, but the Yu-feng Gu does not disclose or suggest other non-summary metrics of the business that may be seen over a single screen at a given point in time. Further, Yu feng Gu refers to the data views only, the disclosed multiple screen dashboard does not address data origination—and it is data origination and adjustment that is the actual base task of a stock management system (e.g. product creation, stock entry, barcode production, customer creation) or data editing (e.g. price changes, transfers, supplier returns, tracking each customers' purchases), etc. The inventory is a major asset that represents tied-up capital, managing stock effectively enables a business to free up capital. This helps keep stock at a reasonable level, balancing the need for surplus supplies to satisfy potential customer demand with the need to reduce tied-up capital. Thereby, it is important to address the data origination for effectively ordering, storing, tracking, and controlling inventory, which is lacking in the disclosed prior art.

In particular, the reference '955 to Jonathan A. Gilman discloses a method of providing access to and presenting information from a third-party business management software system. The third-party business management software system comprises a database for storing customer data related to a plurality of customers. The method comprises providing an interface for display on a user computer, the interface is accessible via an internet browser coupled to a network, receives input from a user via the interface identifying a customer from the plurality of customers, is responsive to the input from the user, accesses the third-party business management software system to obtain customer data associated with the identified customer, and presents the customer data to the user via the interface in a single view. Some aspects include a system comprising at least one application computer for performing the above method. However, unlike the subject matter of the disclosed invention, Gilman's description relates to the presentation of limited data only, not to an entire underlying stock management system. Jonathan A. Gilman discloses a method of presenting data over a single view for only customer data associated with the identified customer but does not disclose or suggest how the same single screen views can accommodate data sets, entry, amendment of multiple business applications such as tracking stock, sales, purchase and sales orders, customers, etc.

In particular, the reference '370 to Howarth Christopher discloses a method and system for inventory management that includes collecting sales information such as a stock-keeping unit (SKU), a sale date, and a sale quantity, from one or more sources, wherein the sources comprise a manufacturer, a plurality of distribution channels for a manufacturer, a store, a plurality of stores under a plurality of umbrella organizations and a plurality of brands. The prior art further discloses a user or graphical user interface (GUI) that allows for navigation through the various reports and access to different functions via a dashboard-type GUI and allows the GUI to display reference data from a retailer/wholesaler/manufacturer such as product id, product description, product variety, product size, category id, sub-category id, sub-sub-category id, supplier id, RSP, sales margin, sales tax rate, and barcode. However, unlike the subject matter of the disclosed invention, Howarth Christopher does not discuss or suggests about the representation of the data over a single GUI, in order to enhance the readability and accessibility of the data for a user.

In particular, the reference '573 to Hornsby Nathan discloses a method of generating an inventory management graphical user interface (GUI) in a web-browser and maintaining a stock database including counts of inventory of a plurality of items. The prior art discloses a plurality of user tiers wherein each user tier has a different GUI with different controls that interact with a plurality of shopping carts and a branch-cart selection interface that indicates the particular branch the user is reviewing and in the centre of the screen each branch is displayed and selected individually. Each branch is displayed within the individual address and an associated cart that is managed individually with individual request lists and each branch has an analytic tracking screen that generates reports for inventory expenditure within each branch. However, unlike the subject matter of the disclosed invention, Hornsby Nathan does not discuss or suggests about representation of the generated reports over a single GUI and at the same time, nor that the interface can be used for product creation, stock entry, transfers, price adjustments, order entry, customer tracking etc.

None of the prior art provides the conceptual framework or all the multiple variations of lists or matrix data input or output, selectable data types and instantly re-configurable user choice of data content/format from within a single screen format (for all data types) that a user would need if they were to avoid the drudgery, fragmentation, time consuming menu-driven navigation, inconsistency and hence the inefficiency of conventional systems. Therefore, there remains a need for a more efficient and user-friendly approach to manage and represent data and data entry related to stock management for an end-to-end user in text and graphical form over a single and inherently consistent graphical user interface.

### SUMMARY OF THE DISCLOSURE

In accordance with an embodiment, the present invention discloses a locally based or web-based inventory management system. The locally based or web-based inventory management system comprises a computing device having a processor coupled to a memory, and communicatively coupled to a server over a network interface. The memory comprises a set of instructions executed by the server. Further, the computing device comprises a stock management interface (SMI) which is in communication with the processor. The SMI is configured with a plurality of screen views to organize and display a single screen interface standard to all relevant data types. The plurality of screen views comprises a browser, a side panel, an input screen, and a drilldown. Further, the web-based inventory management system comprises a database coupled to the server and configured to store data related to one or more activities of a supply chain management environment tracking raw material components, finished goods, sales, orders etc. (also known by a variety of other terms including stock management system or inventory control system or stock control system or enterprise resource planning system). The one or more activities include product details required for physical retailing/wholesaling/warehousing, all the additional product details needed for combining multiple product variants into one product, transferring, web retailing/sales, stock details, order details, sales details, sale values, currencies, customer details, customer purchase history, staff/staffing information, profit values and like information for supply chain management systems for one or more inventories. Data required for any such purposes can be entered manually or imported digitally, likewise such data can be exported (or imported) in a variety of formats required by remote/mobile elements of the system itself and also various third-party software programs. Further, the database comprises one or more program modules to be executed by the server to handle one or more stock-keeping units (SKUs) with respect to the one or more activities. The one or more program modules further enable navigation between the plurality of screen views by interacting within the single screen interface (FIG. 1, 114) disclosed herein as a focus screen.

In one embodiment, the SMI corresponds to a focus screen to display the data related to the one or more activities at a time via four components, the browser, the side panel, the input screen, and the drilldown. The focus screen is preferably a touch screen and/or a non-touch screen adapted to run on any type of operating system (OS), such as iOS, Windows, Android, Unix, Linux and/or others. The browser is configured to retrieve information requested by a user. The side panel is configured to provide supporting data for the actions performed by the user on the browser. The drilldown is configured to represent and access context specific data in conjunction with the data represented over the browser. The input screen is configured to receive instruction inputs given by the user regarding the data of the one or more activities as represented over the browser. Not reviewed herein is the inventory systems standard and separate Settings option.

In one embodiment, the one or more program modules further enable one or more data entries related to the browser such as selecting columns on the browser via the side panel and then using drag and drop options to position the columns, setting from/to dates for each column, sequencing and grouping by columns, applying filters to each of the multiple columns to display data of the selected columns over the browser, representing the filtered items as a display of data columns, a printed report or as a chart/graph for all columns selected, or on the side panel, for just one product; plus using a right click option for the one or more activities such as selecting input choices, creating new products/customer/transactions, transfers, editing etc. In one exemplary embodiment, a Statistics Console component of the input screens also provides intuitive, user selected, decision supporting data.

A non-transitory computer readable medium having one or more program modules for storing instructions executed by a processor communicatively coupled over a network interface is disclosed. Further, the one or more program modules are executed by the server to handle one or more stock-keeping units (SKUs) with respect to one or more activities. Further, enable navigation between a plurality of screen views by interacting within a single screen interface, wherein the plurality of screen views comprises a browser, a side panel, an input screen, and a drilldown and enable one or more data entries onto the browser using a right click option for the one or more activities, wherein the one or more data entries related to the browser comprises: selecting and positioning of multiple columns on the browser via the side panel using drag and drop options and applying filters to each of the multiple columns to display data of the selected columns over the browser and representing the filtered items as a display of data columns or as a chart/graph.

It can be noted that, compared to traditional systems (with their multiplicity of task orientated, inconsistent, screens) the present invention discloses one screen only, and much of the systems superior accessibility and power is a direct consequence of the single screen approach. Being a single screen, the present invention discloses systems and methods that allow the user to perform a large number of normally separate, complex, and complicated stock management related tasks in one place (alongside all necessary user selected decision-supporting information not simultaneously available in traditional systems) with minimal system navigation and complete consistency, so making system usage far more intuitive, easier, taking less time and with minimal user effort. As a direct consequence of this leap in interactive flexibility and power, many additional capabilities become available to the user. In particular, this has necessitated the formulation of anew stock management concept, the SKC (Stock Keeping Composite) wherein the dimensions included within the stock, sales, orders etc. for a single overall product are re-defined at will by the user.

In one exemplary embodiment, the SMI provides a consistent set of features which may be applied to the user's products/inventories/sales, historical transactions, or contacts (including customers) and if required data is always available in a parent child relationship. When the SMI is product orientated, the products become the gateway for all functions and information a user may require relating to one or to multiple products. In another exemplary embodiment the browser, the Expand format or Drilldown provide a window with more granular details, so for products this might be a breakdown of stock, sales, etc. for varied sizes, colours, fits and locations where the products come in or are held/or moved within/or are re-classified within/or exit the system etc. Similarly, when the SMI is transaction orientated, the transactions browser, expand format, drilldown and side panel become the gateway for all functions and information a user may require relating to one or to multiple transactions. Likewise, when the SMI is contacts orientated, the contacts browser, Expand, drilldown and side panel become the gateway for all functions and information a user may require relating to one or to multiple contacts.

It will be apparent to one skilled in the art that examples mentioned in the draft have been provided only for illustration purposes and as an exemplary embodiment, without departing from the scope of the disclosure and that the system will have many features and facilities not detailed herein because they are not directly relevant to the inventive nature of the product itself e.g. detailed screen content in any particular data orientation, details of website linkage, pricing and promotions, customer loyalty etc.

### BRIEF DESCRIPTION OF THE DRAWINGS

The accompanying drawings illustrate various embodiments of systems, methods, and embodiments of various aspects of the disclosure. Any person of ordinary skill in the art will appreciate that the illustrated element boundaries (e.g., boxes, groups of boxes, or other shapes) in the figures represent one example of the various boundaries' representative of the disclosed invention. It may be that in some examples one element may be designed as multiple elements or that multiple elements may be designed as one element. In other examples, an element shown as an internal component of one element may be implemented as an external component in another and vice versa. Furthermore, elements may not be drawn to scale. Non-limiting and non-exhaustive descriptions of the present disclosure are described with reference to the following drawings. The components in the figures are not necessarily to scale, emphasis instead being placed upon the illustrated principles. Data in each illustration may be different/inconsistent with any similar data in another illustration

Various embodiments will hereinafter be described in accordance with the appended drawings, which are provided to illustrate and not to limit the scope of the disclosure in any manner, wherein similar designations denote similar elements, and in which:

FIG. 1 illustrates a block diagram showing a web-based inventory management system for stock management, according to an embodiment of the present invention;

FIG. 2 illustrates an exemplary screenshot of a stock management interface (SMI) showing products/inventory sequence based on Product Reference number, user selected essential data columns, totals for relevant columns over a browser, and column chart for a highlighted product over a side panel, according to an embodiment of the present invention;

FIG. 3 illustrates an exemplary screenshot of the SMI showing a browser product sequence by type over the browser and a pie chart for the highlighted product over the side panel using a product's data, according to an embodiment of the present invention;

FIG. 4 illustrates an exemplary screenshot of the SMI showing the browser product grouped by type to automatically display with sub-totals over the browser and a picture with additional data for the product highlighted on the browser product over the side panel, according to an embodiment of the present invention;

FIG. 5 illustrates an exemplary screenshot of the SMI showing contact data over the browser and additional data of highlighted contacts over the side panel, according to an embodiment of the present invention;

FIG. 6 illustrates an exemplary screenshot of the SMI showing transaction data over the browser and additional data for the highlighted transaction over the side panel, according to an embodiment of the present invention;

FIG. 7 illustrates an exemplary screenshot of the SMI showing a filter options multi choice pick list, according to an embodiment of the present invention;

FIG. 8 illustrates an exemplary screenshot of the SMI showing right click options for product-oriented data over the browser, according to an embodiment of the present invention;

FIG. 9 illustrates an exemplary screenshot showing right click options for transactions-oriented data over the browser, according to an embodiment of the present invention;

FIG. 10 illustrates an exemplary screenshot showing right click options for contacts-oriented data over the browser, according to an embodiment of the present invention;

FIG. 11 illustrates an exemplary screenshot showing product-oriented drilldown to a multi-variant dimension matrix, according to an embodiment of the present invention;

FIG. 12 illustrates an exemplary screenshot of the SMI showing product-oriented drilldown to the multi-variant dimension matrix, representing an active “Colour” and also an active “Location” pivot buttons within Rows and with only a “Size” pivot button active within Columns, according to an embodiment of the present invention;

FIG. 13 illustrates an exemplary screenshot of the SMI showing the product-oriented drilldown to the multi-variant dimension matrix, representing first an active “Location” then followed by an also active “Colour” pivot buttons within Rows and only “Size” pivot button active within Columns, according to an embodiment of the present invention;

FIG. 14 illustrates an exemplary screenshot of the SMI showing the product-oriented drilldown to the multi-variant dimension matrix, representing only the “Colour” pivot button as active within Rows; while the “Location” and then the “Size” pivot buttons are active within Columns, according to an embodiment of the present invention;

FIG. 15 illustrates an exemplary screenshot of the SMI showing transactions-oriented drilldown to view a Transfer line's in/out transfer docket, according to an embodiment of the present invention;

FIG. 16 illustrates an exemplary screenshot of the SMI showing transactions-oriented drilldown to view a Direct Stock In line's detailed SKU docket, according to an embodiment of the present invention;

FIG. 17 illustrates an exemplary screenshot of the SMI showing contacts-oriented drilldown to view a Customer Line's Receipts docket, according to an embodiment of the present invention;

FIG. 18 illustrates an exemplary screenshot of the SMI showing a blank matrix input screen for a multi variant product, according to an embodiment of the present invention;

FIG. 19 illustrates an exemplary screenshot of the SMI showing a blank matrix input screen for a multi variant product with a statistics console displaying data for the highlighted line, according to an embodiment of the present invention;

FIG. 20 (A) illustrates an exemplary screenshot of the SMI showing a transfer/move input screen for a multi variant product with the statistics console displaying data for the highlighted line, according to an embodiment of the present invention;

FIG. 20 (B) illustrates an exemplary screenshot of the SMI showing a transfer/move input screen for a multi variant product with single statistics console displaying data for the highlighted line, according to an embodiment of the present invention;

FIG. 21 (A) illustrates an exemplary screenshot of the SMI showing with data lines not expanded at all, so each product is just one line containing all the information for every SKU within the product; the configuration tab of the side panel provides details of all active filters, order (sequences), group by's, expand by's and locked columns, according to an embodiment of the present invention;

FIG. 21 (B) illustrates an exemplary screenshot of the SMI showing data lines expanded by colour, so there is one line for every different colour of a product; the configuration tab of the side panel provides details of all active filters, order (sequences), group by's, expand by's and locked columns, according to an embodiment of the present invention;

FIG. 22 illustrates an exemplary screenshot 2200 of a single product called Willow expanded view over the browser panel (via the right click option); data lines are expanded by both size and colour (and fit where applicable), so there is one line for each product in each size in each colour, according to an embodiment of the present invention;

FIG. 23 illustrates an exemplary screenshot 2300 of presentation of product details for products called “Saqib”, “Alison” and “Lensha”; this displays one line per whole consolidated product (as does FIG. 21 (A)); this FIG. is included however so that the reader can see the changing presentation of the stock for “Alison” between this and subsequent FIGS., according to an embodiment of the present invention;

FIG. 24 illustrates an exemplary screenshot 2400 of presentation of product “Alison” expanded into its stock keeping units (SKU's), according to an embodiment of the present invention; and

FIG. 25 illustrates an exemplary screenshot 2500 for presentation of product “Alison” as a matrix, according to an embodiment of the present invention.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items.

It must also be noted that as used herein and in the appended claims, the singular forms “a,” “an,” and “the” include plural references unless the context dictates otherwise. Although any systems and methods similar or equivalent to those described herein may be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

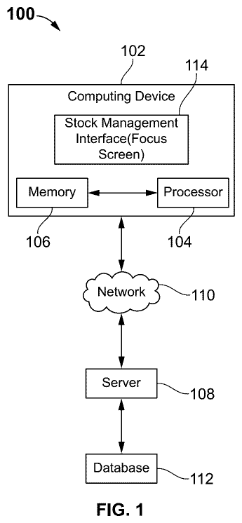

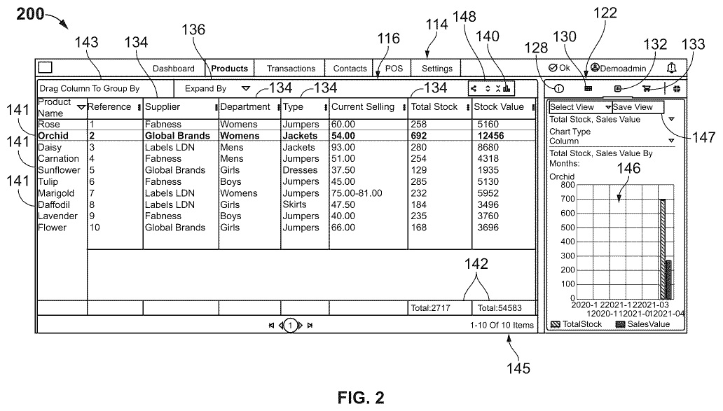

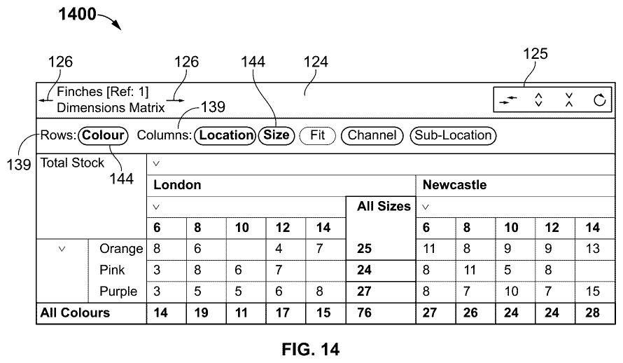

FIG. 1 illustrates a block diagram of a web-based inventory management system 100, according to an embodiment of the present invention. FIG. 1 is described in conjunction with FIGS. 2-25. The web-based inventory management system 100 comprises a computing device 102 having a processor 104 coupled to a memory 106, and communicatively coupled to a server 108 via a local or internet network interface 110. Further, the web-based inventory management system 100 comprises a database 112 coupled to the server 108. Further, the computing device 102 may comprise a stock management interface (SMI) 114 in communication with the processor 104 and configured with a single screen interface within which is a plurality of screen views. It can be noted that the SMI 114 corresponds to a focus screen and that any feature of a focus screen is by definition system-wide, since the single screen interface SMI 114 is the only day-to-day operational screen in the hub system. In one embodiment, the focus screen may be a touch screen and/or a non-touch screen adapted to run on any type of operating system, OS, such as iOS, Windows, Android, Unix, Linux and/or others. The SMI 114 may represent data over a single screen interface standard to all relevant data types. The single screen interface that is standard to all data types includes a browser, a side panel, a drilldown, and an input screen, some parts of which are shown in FIG. 2.

The single screen interface of the SMI 114 corresponds to a Focus Screen, so providing a consistent set of features which can be applied to the user's products, historical transactions or contacts (including customers) and if required data is always available in a parent child relationship. When the Focus Screen is product orientated, the product becomes the gateway for all functions and information a user may require relating to it, or to multiple products—and in one embodiment the Expand format or Drilldown format provide a window with more granular details such as a breakdown of stock, sales etc. for the varied sizes, colours, fits, locations etc. the products come in or are held/or moved within/or re-classified within/or exit the system etc.; the side panel may also provide supporting product data. Similarly, when the SMI is transaction orientated, the transactions become the gateway for all functions and information a user may require relating to one or to multiple transactions. Likewise, when the SMI is contacts orientated, the contacts become the gateway for all functions and information a user may require relating to one or to multiple contacts.

For example, in one embodiment of a contacts oriented data browser, expand or drilldown provides a window with more granular details such as which products were purchased as part of a sale to a customer; while the side panel may provide data as to that customers' total purchase quantity, value, frequency etc. for the customer highlighted on the contacts browser. Likewise, in one embodiment of a transaction orientated SMI 114 the expand or drilldown provide a window with more granular details on what was received, transferred, purchased etc. within the relevant transaction line highlighted on the browser; in one embodiment, for a received order, the drilldown may provide granular details of the items received while the side panel may provide data on a suppliers' reliability, overall percentage spend allocated to these products within the season etc.

So, the single screen interface, architecture, navigation, functionality, ‘look-and-feel’, behaviour and layout is consistent across all data orientation—whether the data is orientated around products, transactions or contacts. For clarity, the system employs a clear naming and colour coding convention for different screen types. Access to the system modules and features may be limited based upon the license configuration the user has purchased or the user's security level.

The memory 106 may be linked with the server 108. The memory 106 is configured to fetch the data based upon the request fed by the user through the browser. The memory 106 in line with the request fetches the data that is to be further processed by the server 108. It may be noted that the memory 106 is an on board memory that is installed within the user's device. The memory 106 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware).

Further, the server 108 that is linked with the memory 106 fetches the request from the user's device 100 and based upon which extracts the required data from the database. Further the extracted data from the database is pre-processed and returned to the user's device 100 according to the user's command. In an embodiment, the server 108 may produce a data grid from one or more activities of a supply chain management system based upon the data fetched from the database 112, that may be further illustrated over the SMI 114. It may be noted that the database 112 may comprise one or more tables and each of the one or more tables may comprise information on the one or more activities. Herein, the data grid may be the accumulated data extracted from one or more tables. The server 108 fetches the data from the database 112 across the one or more tables of all the one or more activities, based upon the user command. Further, the processor 104 is configured to use the data returned from the server 108 to formulate and present the screen (grid) for the user.

In one embodiment, all data is retrieved and pre-prepared by the server 108 and then presented to the user by the processor 104. The server processes the data from the database and formats it to a format which the client processor (104) accepts, the local processor 104 then processes formatted data received from the server for presentation on screen. Herein within this document all references to the processor 104 shall be taken to mean that the data being referred to is being retrieved from the database 112 by the server 108 and forwarded pre-processed to the processor 104.

Herein, the server 108 may use a mapping process to segregate the data required by the user from the database 112. The server 108 may execute the mapping process by determining a target data table based upon the requirement of the user from the database 112. In one embodiment, the user requirements include at least one of accessing and/or updating customer details, inventory details, tracking and managing stock, sales and purchase of stocks, or stock details. Further, the server 108 may only fetch the essential information from the target data table for the one or more activities. The server 108 may generate one or more reports based upon the data fetched through the target data table by reshaping the data into the SMI 114 between the browser, the side panel, the drill down, and the input screen.

Further, the computing device 102 may generate the SMI 114 with the help of the processing unit 104. The SMI 114 may present the data to the user. The functions of the SMI 114 may include, but are not limited to, handling single or multiple variance/stock-keeping units (SKUs) per product, historical transactions, sales, orders (e.g., purchase orders and sales orders) and all contact details (e.g. staff and customers). In an embodiment, the browser, the side panel, the drilldown, and the input screen may be invoked as needed by the user, over a single screen interface standard to all data types of the SMI 114.

Further, the browser may be used to enter information such as the data required for product/contacts/transaction creation or editing, including all the needed physical and web based product details, stock receipt, sales orders, and purchases, transfers, contact information and amending/editing historical transactions. The side panel may provide supporting data for the actions the user is performing, or wishes to perform, on the browser. The drilldown/expand options may provide additional more granular data apart from the browser. The data exposed on drilldown/expand may be context sensitive and may vary depending upon the data type represented within the browser. All screen components may allow the user to enter commands to fetch any required data as appropriate. The input screen may be accessed by the user by clicking either a short cut options on the browser or via a right click option over the browser. The input screen may vary depending upon the data orientation of the browser and/or the type of data line on the browser.

In one embodiment, the web-based inventory management system 100 may comprise the server 108 linked with the database 112. The server 108 may allow the user to access and interact with the data that is stored within the database 112. The server 108 may search and fetch the data from the database 112. Herein, the data may comprise information of the one or more activities related to a supply chain management environment e.g., automated and/or synchronous data exchange from/to various sources such as Excel, CSV files, web sites, accounting systems, external customer management systems or marketing systems/tools and external devices such as tills or hand held devices etc. The one or more activities may include the addition/editing of product details, stock details, order details, sale values, currencies, customer details, transactions, staff, and profit values for one or more products etc. In one embodiment the user can define a wide range of default data/options so that large elements of manual data input can be eliminated e.g. automated price calculations and rounding per outlet based on the cost price, automated messages thanking web customers for their order, the auto population with data of the most common entries for fields within a new manually created item (which the user can then change if needed) etc. Herein, the one or more products or inventories include but are not limited to raw materials, finished goods, work in progress products, goods in transit, goods of varied status (e.g. sold but not dispatched), packaging materials, units of measure such as variable lengths of cloth, etc.

Further, the one or more tables of the database 112 may provide a decoupling of responsibilities, i.e. sales values may only store and care about sales related activities, customer details may only store and care about customer related activities, etc. The database 112 may be a relational structure query language (SQL) database that may store and provides access to data points that are related to one another within a database and across databases. The database 112 thereby, may provide an intuitive, straightforward way of representing data in the one or more tables where each row in the one or more tables may be recorded with a unique ID called a key. The columns of the one or more tables may hold attributes of the data, and each record may have a value for each attribute, making it possible to establish the relationships among data points. In one embodiment, the server 108 may be further configured to form a single output response for the user on the basis of data provided by several databases. For example, sales values having details about sales related activities and customer details having details about customer related activities may be fetched by the server 108 and based upon which a common table may be created showing both the results to the user's screen.

Further, the database 112 may comprise one or more program modules that may be executed by the server 108. The server 108 may execute the one or more program modules to handle single or multiple variance/stock-keeping units (SKUs) per product, enable navigation by interacting within a single standard focus screen whose components are the browser for products or transactions or contacts, the side panel, the input screen, and the drill down. Further, the server 108 may enable one or more data entries for the data line highlighted on the browser via a right-click option for particular options relating to the one or more activities. It can be noted that the one or more data entries are automatically saved within the database periodically. In one embodiment, the one or more activities may comprise entering/editing data, such as product or customer creation; stock receipt, wholesale sales orders, purchase orders, transfers and goods in transit, noting product's location within a shop or warehouse, noting goods status such as damaged, layaway etc. Further, the server 108 may enable the user to select multiple columns on the product browser via the side panel and also enable the user to position the multiple columns in a sequence using drag and drop options. Further, the server 108 may enable the user to apply filters to each of the multiple columns, thereby displaying data of the selected products/transactions/contacts on the product browser. Further, the server 108 may enable all filtered items as either a display of data columns or as a chart/graph.

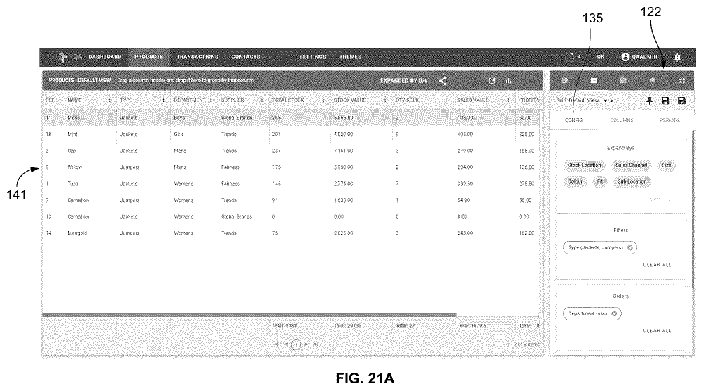

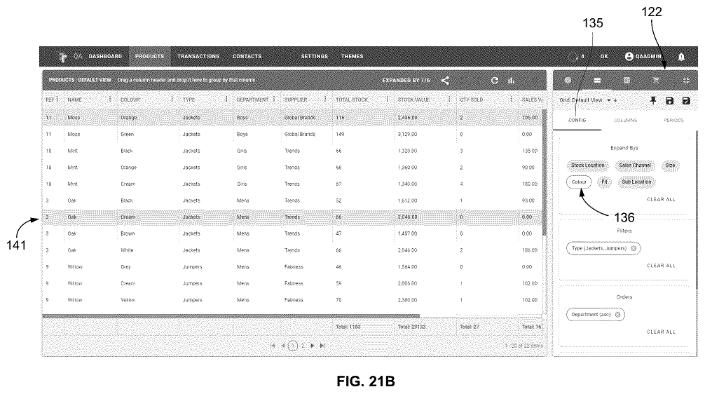

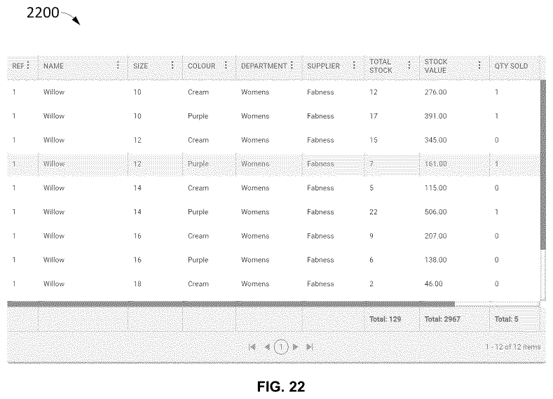

Successively, the processor 104 may enable the user to sequence products or transactions or contacts for any one or more column and to group, sub-group, sub sub-group etc. the product browser by any one or more column type while also displaying relevant sub totals etc. The processor 104 may further enable consolidated data lines on the browser (each cell of which contains the users' choice of data columns) to be broken down/expanded into one or more combination of elements for one or more parameters of the one or more products, see FIG. 21(A) and FIG. 21(B) and FIG. 22. In one embodiment, the one or more parameters include colour, size, fit, location, channel, and sub-location of the one or more products. Further, this expansion or breaking of data lines on the browser into the one or more combinations of dimensions for the one or more parameters of the one or more products/transactions/contacts may be charted, filtered using facilities previously mentioned in various ways including by date, sequenced, broken down or grouped—in all cases this is achieved using the on-screen facilities common to all Focus Screen browsers. FIG. 21 (A) exhibits the Focus Screen ability to interactively define and instantly display re-formulated “SKU's”, made up of just the dimensions within a product the user needs at that moment—henceforth referred to as an SKC (Stock Keeping Composite). For example, the products within FIG. 21 (B), have both size and colour, but the user has selected to see the products by colour only (i.e. not including their sizes). Throughout the SMI 114 users can opt to see products broken down into any SKC they require i.e. any selected combination of their dimensions in both expanded and dimension matrix formats. Further, the processor 104 may enable the user to adjust the one or more parameters, prices etc. of the one or more products on a browser display using a batch mode option available on the right click. Further, the dimension matrix has its own side panel which works in exactly the same way as that for the browser and in this way the user may view a configurable multidimensional matrix view of the product while linked with all the optional views and capabilities of the side panel. Alternatively, the “Expand by” option 136 allows the user to see the same browser data in a list format, also linked to the side panel; for example, Expand-by colour, as shown in FIG. 21(B)

Further, the one or more program modules executed by the processor 104 may facilitate a hub system to enable extra data entry options for e-commerce websites. The hub system may be configured to provide import/export to third party apps such as web sites, accounting systems etc., the hub also provides a facility to set optimum patterns, monitors stock levels, generate purchase orders and transfers automatically and allow the user to update/refresh the data and also export the data both automatically or at the user instigation. “Expand by” option 136 is alternatively available per product as a drill down or via right click. Further, the one or more program modules may be executed by the processor 104 using algorithms and/or an artificial intelligence and machine learning module (AI/ML) (not shown). This is particularly relevant to the analysis of the systems extensive historical data storage and will result in numerous analytical benefits particularly related to the automatic generation of the systems purchase orders, transfers, and optimum stock levels etc. Further benefits are envisaged in numerous areas including customer management, marketing communications and reporting.

Further, the network interface 110 may be communicatively linked to the server 108. The network 110 may establish a wired or wireless connection with the server 108 to fetch and transfer the stored data within the database 112 and send to the computing device 102. Herein, the network interface 110 may be, but not limited to, Wi-Fi, Bluetooth, a wireless local area network (WLAN)/Internet connection, and a radio communication. The network interface 110 may comprise a transmitter and a receiver, wherein the transmitter may emit radio/digital signals that may be picked up by the receiver. It can be noted that the data stored within the database 112 may be first converted into radio/digital signals, and are further converted back into data which is a readable data.

In one embodiment, the web-based inventory management system 100 may be a non-transitory computer readable medium having one or more program modules for storing instructions executed by the processor 104 communicatively coupled over the network 110. The one or more program modules are executed by the processor 104 to handle one or more stock-keeping units (SKUs) with respect to one or more activities; enable navigation between a plurality of screen views by interacting within a single screen interface. The plurality of screen views comprises a browser, a side panel, an input screen, and a drilldown also referred here collectively as the “Focus screen”. Further, the processor 104 may enable one or more data entries onto the browser using a right click option for the one or more activities. The one or more data entries related to the browser include selecting and positioning of multiple columns on the browser via the side panel using drag and drop options and applying filters to each of the multiple columns to display data of the selected columns over the browser and in different formats and for different dates e.g. grouped, sequenced etc. and representing the filtered items as a display of data columns or as a chart/graph.

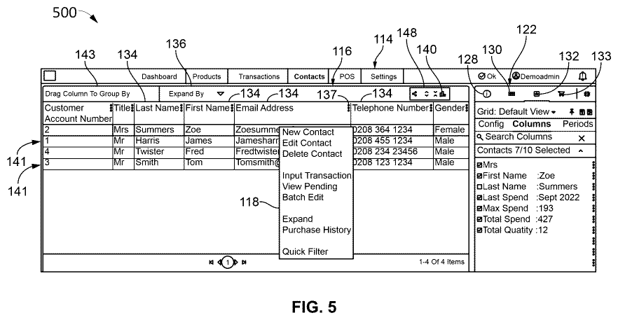

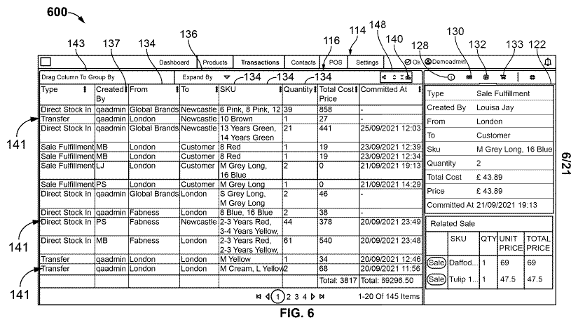

FIG. 2 illustrates an exemplary screenshot 200 of the SMI 114 showing products default sequencing (by reference number), essential user selected data columns, product names (user defined and can be alpha numeric), totals for relevant columns over a browser 116 and column chart for the highlighted product over the side panel. The browser 116 may have at least three different data perspectives i.e., product-orientated—as in FIG. 2; transaction-oriented—see FIG. 6 such as, by sales receipts, transfer, purchase order, stock receipt or as shown in FIG. 5 contacts-orientated—such as, by the customer, staff member etc. In one embodiment, the at least three different data perspectives may also refer to as a product browser, a contacts browser and a transaction browser. All the actions performed by the user are executed by multiple navigation menu types and context sensitive menu's/options configured over the SMI 114, that may be horizontal text-based navigation, Column Heading options, Hamburger Menu, Mega Menu, Scroll-Triggered, Vertical Sidebar Navigation, Hover Activated Dropdown Menu and Sticky or Fixed Menu, including drag and drop, user defined and automated menu options amongst others.

BROWSER: The browser 116 is the main Focus Screen element (supported by the linked Side Panel). The browser 116 normally occupies all or three quarters of the Focus Screen, depending upon if the Side Panel is minimized or maximized; Input and Drilldown screens float above these (although there is also an option to dock these below the browser/Side Panel).

The browser 116 initially displays columns and summary data lines for consolidated products, consolidated transactions or consolidated customers across the screen as in FIG. 2. For a more granular view of any or all such consolidated data lines on the browser 116, the user can expand one or more lines (e.g., consider a single consolidated product made up of six sizes, three colours and with stock held at two locations: as a consolidated product this would occupy one line on the browser 116, but if fully expanded, will instead instantly display 36 lines i.e., 6×3×2—with every cell in every line, based upon the user's column choices, correctly populated with data for that line). In one embodiment, the user may want to expand one or more consolidated product lines as in FIG. 21(A), but by only some of its dimensions e.g. by colour only as in FIG. 21(B), once actioned every product will now be displayed with a line for each of its colours, as in FIG. 21(B). This is the new type of product formulation that the inventor characterises as a “Stock Keeping Composite” (i.e. an SKC)—so the product “Mint” is one consolidated line in FIG. 21A, but three granular lines in FIG. 21B, (i.e. an SKC for the product by colour). It is a composite because it does not always include all the products dimensions e.g. the example herein for “Mint” FIG. 21B does not display size as a separate component of the SKC. Further, in addition to building SKC's from any combination of a product's inherent dimensions (e.g. a product's sizes, colours and fits) the invention makes it possible to also include an additional, “spatial”, component e.g. location (i.e. real world), sub-location (real world or virtual depending upon how the user classifies the sub location) and sales channel (real world in the case of say shops, but virtual in the case of a web site). As a consequence of the SKC's extended spatial capability, if the use wants to see the performance of their products/styles (or just one style) still by colour, but also at each of their shops, they could then opt to add location to the expand option; the SKC could then be said to be for the product, by colour and location (so the SKC, at that moment, does still not display size as a separate component). As the reader can see, the SKC's content is not fixed in the way that is true for the traditional SKU; the SKC's generated via SMI 114 are completely flexible and can be instantly defined and re-combined by the user at any time and in any of the systems formats. Further, within the browser 116, the right click option provides edit/input options for the highlighted data line; column headings provide filtering, sequencing and grouping options; column totals and sub totals are always visible; from/to dates can be set for any column, columns can be dragged/dropped to any position on the browser 116; a flexible ‘Group by’ option is also available. Along the top of the browser 116 are a range of appropriate options that can be applied to all the data being displayed e.g. print, export to Excel, Expand, show sub totals only (if a ‘Group-by’ has been applied), chart the data etc.

Further, the expand function, with its configurable ability to instantly build any combination of stock keeping dimension into an SKC, allows for a far more efficient cross product reporting than conventional systems with their one rigid, fully expanded, SKU's format. Using an example where expand by colour has been applied (and so a colour column has been automatically added, as in FIG. 21(B) the presence of a colour column enables the user to filter by one or multiple colours; for example, to see the performance of a particular product/style or multiple products across the business overall for just one colour (if they wished they could filter for multiple selected colours), and then the user might sequence on sales value to see best performers for that one colour. User may also group products, generate charts, filter on multiple columns etc. If the user then wants to see how each individual shop is performing for the one colour, the user may simultaneously choose to also expand by location (so that every line is for a product, by colour, by location—the location column is automatically added to the browser) and then the user may filter by location or may group by location to see all the lines grouped into, say, two locations. Because grouping has been invoked for location there will be product lists with sub-totals for each location and because all the product/colour/location lines might spill across many screen, the user may wish to invoke the summary option and the screen would display just three lines, one summary line for the colour at shop A, another summary line for the colour at shop B plus a totals line combining both shops for that one colour. The combinations and flexibility are easily navigated and practically infinite. The highly granular Expand-by can be applied to either all products on the browser or just one. If the user selects from the Expand-by pick list at the top of the browser, then all products in the browser are expanded based on the users' selection of expand options. If the user uses the right click Expand option, then only the product currently highlighted on the browser is expanded, not all products. This same flexibility to create and display SKC's is expressed in the Dimension Matrix by having pivot buttons that may be turned on or off and may be repositioned into either rows or columns.

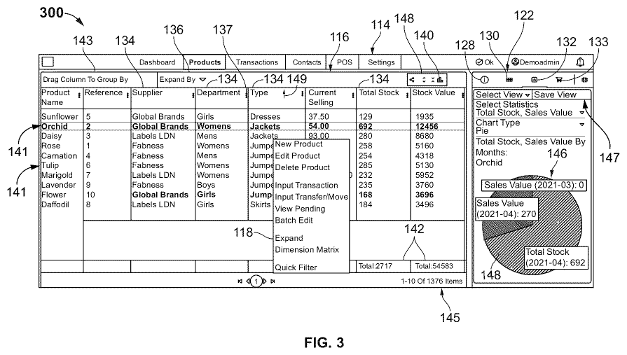

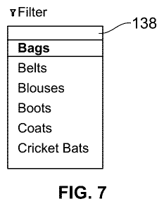

In one embodiment, the browser 116 may be configured to display vertical data columns 134 and horizontal data lines 141. In one embodiment, each of the vertical data columns 134 are provided with a 3 dots menu FIG. 2, 137 (also called Kebab menu). By clicking the 3 dots menu 137, provides an additional option list for filtering on the respective vertical data columns 134 such as multiple-choice filtering (FIG. 7, 138), locking the column in place etc. Filtering can also be actioned via the context sensitive right click ‘Quick Filter’ option as shown in FIGS. 3, 5, 8, 9, 10. In one embodiment, the horizontal data lines 141 on the browser 116 may include multiple user selected statistical cells based upon the users column choices, such as stock quantity, stock value, sales quantity, sales value, purchase orders or sales orders quantity and value, mark-up, margin, various selling prices, various cost prices, dates relating to automatic price change dates etc. In one embodiment, the user may select one of the many users defined parameter or statistical columns via the side panel 122, such as via the column/field tab 130 as shown in an exemplary screenshot FIGS. 2, 3, 4, 5, 6, 21A and 21B. The context sensitive column/field tab 130 provides options for selecting the columns/fields on the associated browser screen and for setting from/to dates for the content of any appropriate column/field.

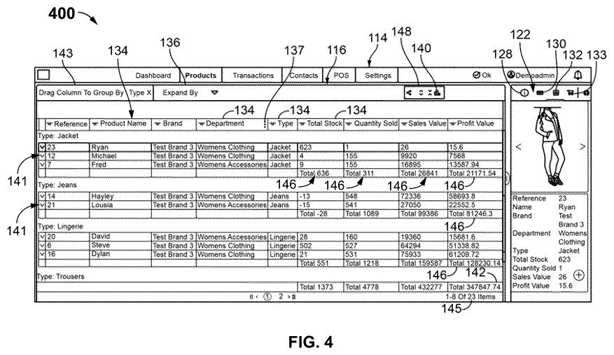

Further, the browser 116 may provide a count of the number of lines currently being displayed out of the total possible lines FIG. 2, 145 e.g. “1-10 of 1376”. So in one embodiment, the browser 116 may provide a fully-fledged and a highly configurable reporting tool with a large choice of user selected statistical columns via the side panel 122, tab 130. In addition, the user may filter the horizontal data lines 141 via their respective vertical data column headings 134 as shown in FIG. 7, and/or sequence as shown in FIG. 3 (using Type) and/or use the “Group by” bar as also shown in FIG. 4 (also by Type in this example). In addition, FIG. 3 illustrates an exemplary screenshot 300 of the SMI 114 showing that the user has selected, using the “Chart Type” pick list immediately above the chart itself, to display a pie chart for the highlighted product on the browser over the side panel 122; whereas FIG. 2 shows a side panel 122 where the user has used the Chart Type pick list to select to display a bar chart for the same product highlighted on the browser. In addition, via their column headings, the user may filter (as shown by 138 in FIG. 7), sequence option (FIG. 3, 149) and “group by” bar (FIG. 4, 143) data lines 141.

In one embodiment, individual/expanded and related information for each of the horizontal data lines highlighted on the browser 116 may display on the side panel 122. For example, a user selection of product pictures as shown on 122, in FIG. 4; user selected chart formats as shown in FIG. 2 and FIG. 3, etc. for the highlighted horizontal data lines 141. Side panel data relates to the single product/transaction/contact line highlighted on the browser. In one embodiment, the browser 116 may provide multi-product user selected charts/graphs for the entire filtered, sequenced and grouped products on the browser 116 at any one time using the whole area normally occupied by product browser. An icon 140 above the browser 116 enables all filtered/sequenced/grouped products in the browser 116 to appear in a user selected chart. When, in one embodiment, a product browser chart, occupies the entire area of the browser 116, the side panel 122 provides configuration choices for the product browser chart. For example, the user may select from the side panel, chart type: select a bar chart, a pie chart, or a graph, etc.; chart data: select sales by quantity, sales by value, stock holding, profitability, margin, etc.; chart breakdown: by the supplier, brand, type, department, etc.; chart dates: select from/to dates for the data being used to generate the chart etc. In one embodiment, the product browser chart may display (using the whole area normally occupied by the product browser 116) a chart or graph broken down to show performance by supplier, type, department etc. for the filtered data set across days, weeks, months etc. for user specified dates, all based on the user's choices at that time. Again, using the side panel 122 the user may also select the product browser chart's axis and data being displayed. In addition, as shown on one embodiment FIG. 2, 147, the user may also choose to save and recall individual browser chart configurations for multiple data lines across the browser, or individual side panel chart configurations for a single product, plus optionally display these on the systems graphical dashboard, or add to a menu option.

A large range of statistical columns may be selected at any time by the user (via the side panel 122); choices depending upon the browsers data orientation. For example, for a product orientated browser, columns for stock quantity, sales value, margin etc., may be selected by the user or for a transaction orientated browser, transaction type, transactions date, transaction value etc. may be selected by the user or for a contacts orientated browser, customer type, customer total spend etc., may be selected by the user. New columns selected by the user from the side panel 122 usually appear to the right of the browser 116 (critical line definition columns will appear to the left). Using a column heading, the browser 116 may then be filtered by any of the multiple options within the vertical data columns 134 as shown in FIG. 7 and may be further configured by using Grouped by 143 or sequence options 149 as shown in FIG. 3.

Further, FIG. 4 illustrates an exemplary screenshot 400 of the SMI 114 showing the browser product grouped by type 143 to automatically display with sub-totals by Type over the browser 116 and a picture with additional user selected data for the product highlighted on the browser product over the side panel 122, according to an embodiment of the present invention. Appropriate column totals are constantly displayed at the bottom of the browser columns as shown in FIG. 4, 142 and sub totals 146 are displayed within the browser if the data has been Grouped 143. In addition, the user may apply from/to dates to any appropriate column (or fields) via the side panel 122 by using the “Periods” tab FIG. 21(A). In one embodiment, selected browser data views could be saved and accessed at any time (via the side panel FIG. 2. 147) and the user may also opt for these to be accessed later via the systems menus and/or displayed on the system dashboard.

FIG. 7 illustrates an exemplary screenshot 700 of the SMI 114 showing example filter options. In one embodiment using the product orientated browser as an example, the user selected statistical columns may be filtered via the column heading as shown in FIG. 7 and columns may also be locked in place from the column headers menu option. In one embodiment, the user may choose to group products lines on the product browser by dragging one or more column headings to the “Group by” bar 143 as shown in FIG. 4. This creates appropriate groups of products on the browser 116 and provides sub-totals 146 as in FIG. 4, for each group. The overall total is always on display at the bottom of the screen 142 as is a visible line count 145. When Group by bar is active (as shown in FIG. 4) the user may select that the browser 116 displays line by line details with sub-totals (the layout shown on FIG. 4) or displays the subtotal lines only via icons 148 at the top of the browser 116. In one embodiment, the user may drag multiple column headings to the “Group by” bar 143 and reposition them at will within the “Group by” bar 143 to instantly change the layout of the product browser and the product list and/or sub-totals 146 within it. In one embodiment these same capabilities apply to all Focus Screens throughout the system, such as for transactions and contacts.

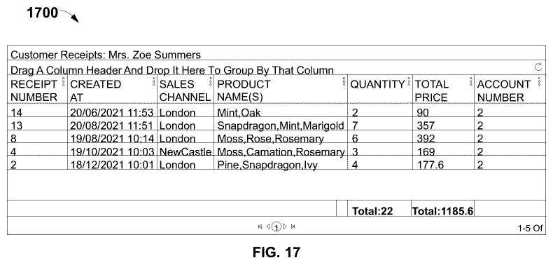

The horizontal data lines 141 as shown in FIG. 21(A) within the browser 116 may be expanded using 136 as shown in FIG. 21(B), as appropriate to reveal the granularity within them. For example, in one embodiment within a contact orientated browser FIG. 5 a horizontal data line 141 is expanded or drilled into as in FIG. 17 to show the individual transactions made by that customer (the exact behaviour of the UI re expand/drilldown options per line can be user configured). In one embodiment, when product orientated, the browser 116 may be configured so that each of the horizontal data lines 141 may expand into multiple lines based upon any single or multiple combination of its dimensions. FIG. 21(B) provides an example of the browser 116 which has been expanded by colour. In one embodiment, the definition of a product may be expanded on demand by any combination of colour/size/fit/+location/channel/sub-location. In this way the browser 116 may provide numerous SKC product breakdowns, such as a line per product per size, a line per product per colour, a line per product per size and per colour, a line per product per size and per colour and also per location. If the relevant vertical data columns 134 are not on the browser 116, when the user selects to expand by option 136 then the necessary column/s e.g., colour, size, location etc. are automatically added to the left-hand side of the browser. Once on the browser 116, the column heading of the added column (as is true of all column heading) may be used to filter, group by, sequence etc.

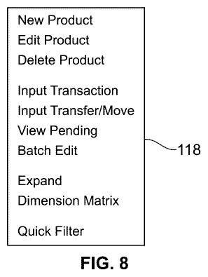

The Expanded view capability may be particularly useful for comparisons across the horizontal data lines 141, for example, when the browser is expanded by colour, FIG. 21(B), using the column header for colour to filter to see the performance of all blue coffee mugs or red garments across multiple products; or if filtering on a browser expanded by both colour and size, to see all red size mediums across multiple products; or when the browser is expanded by size only, just size mediums across multiple products regardless of colour (filtering only on the column header for size) etc. In a further exemplary embodiment, products may be expanded by just location so that the user may see the horizontal data lines 141 for each product at each location on the product browser, thereby enabling the user to review the distribution of the products stock, sales, margin, profitability etc.—per warehouse, shop, or web site. As with previous examples the user could sequence the products based on, say, one or more performance column, group by locations, see location summaries only or filter for say one location only, using the “Location” column heading. As a further example the user could then add colour to the expansion criteria and see/filter/group/sequence the data lines by colours within location groupings or by locations within colour groupings. The expand by option 136 may also be applied to just one highlighted horizontal data line of the horizontal data lines 141 via the right click Expand option as shown in FIGS. 8, 9, and 10. In addition to Input options, the right click also provides other, context sensitive, capabilities. For example, the right click has options to expanding the currently highlighted consolidated data line, options to provide a range of user defined/amendable browser cells or floating data windows depending upon where the user is on the Browser screen e.g. for quick stock input, lookups etc., context sensitive filters and a range of shortcuts.

In one embodiment, the SMI 114 is configured to enable the user to provide ascending/descending rankings for the horizontal data lines 141 based on the user clicking on the column heading as shown in FIG. 3, 149. For numerical columns this ranks the data numerically and for alpha columns the data is ranked alphabetically. Clicking on a column heading Just once ranks data in ascending order, clicking a second time ranks it in descending order and clicking a third time turns off the ranking facility. Herein, note that multiple columns may be ranked at the same time.

In one embodiment, users may choose to add shortcuts icons to frequently used options, for example, on the browser or dimension matrix 124. In one embodiment, the SMI 114 may be configured to enable the user to add a new shortcut, for example, to add/edit a customer or purchase order e.g. the shortcut being added as an icon on the browser 116, or as a menu option or using the right-click option 118 on the browser 116. In one embodiment the user can choose the option they access when doing a drill down, from a range of suitable granularity formats, as appropriate to the data type.

The browser 116 may also be used in a batch mode to perform actions across multiple filtered or unfiltered data lines; once a number of cells in the browser are marked using a mouse drag facility or line-tagged, the user could right-click for context sensitive batch options. In one embodiment, to export the marked/tagged products/contacts/transactions to Excel, or to delete/archive multiple data lines, or to change classifications across multiple data lines, or, particularly on the product orientated browser, if the selling price is marked/tagged, the user may opt to mark-up/down selling prices for all the marked/tagged products etc.

SIDE PANEL: The side panel has a number of tabs so that the user can select different types of options/information e.g. a charts tab, a browser column selection tab etc. and the panel is either minimized to the right of the browser 116 or opens to around a quarter of the way across the screen (larger if the side panel charts option is invoked). The Panel itself displays supporting, context sensitive data for the browsers consolidated data line or the expanded data line the user is on, such as product related pictures, customer summaries, charts etc. The Panel also allows the user to interactively add/remove columns from the browser screen it is associated with, to created date-based columns/fields, to restore previously saved browser data views; it also allows the user to see the browsers current status via the Configuration tab e.g., including which filters, sequences, expansions etc. are currently active, as shown in FIG. 21(A), 122 and FIG. 21(B), 122.

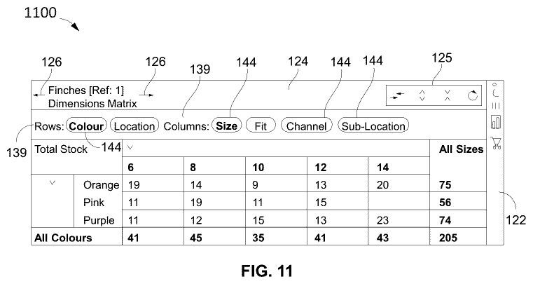

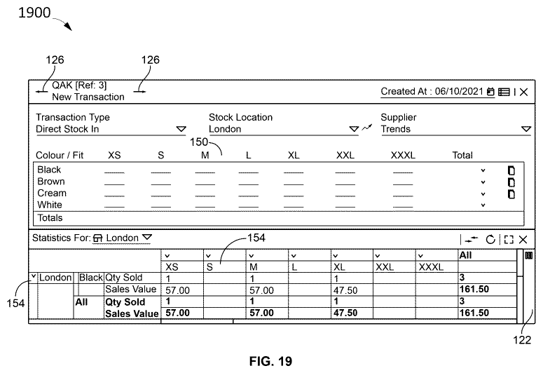

The side panel 122 is attached to all appropriate screens; shown in FIG. 2 maximised and FIG. 11 minimised. The main function of the side panel 122 is to provide supporting data for the actions the user is performing, or wishes to perform, on the associated browser e.g. side panel FIG. 2, 122; the input screen side panel FIG. 19, 122, dimension matrix FIG. 11, 122 and statistics console FIG. 19, 122. The side panel 122 may work in the same way and with the same functionality, look and feel wherever it is found, while the data it displays may be adapted to the associated screen. In one embodiment, the side panel 122 may be opened or closed (minimized). When opened the side panel 122 may be context sensitive and data may appear on it in response to the user actions on the associated screen. In one embodiment, the side panel 122 may comprise at least three tabs i.e., an info tab 128, a column/fields selection tab 130 and a charts tab 132 as shown in FIG. 4. It may also include a series of other useful tools 133 such as, a function to let the user process sales/returns; an option to see system and user messages/alerts. The column tab 130 incorporates sub tabs allowing the user to select or define columns/fields for the attached screen (as an example, by from/to date) as well as displaying the current configuration status of the associated screen, as on FIG. 21(A) and FIG. 21(B), 135.

The side panel 122 may be used to select the data displayed on the associated screen, such as, for the browser FIG. 2, 116, the dimension matrix FIG. 11, 124, input screen FIG. 19, 122 and as part of the statistics console FIG. 19, 154. The interface, behaviour, and data availability of the side panel 122 may be consistent whichever other user interfaces it is associated with (across all the types of data orientation of the associated screen).

In one embodiment, an info tab 128 as shown in FIG. 6 provides extra details for the active data line, for example the line highlighted on the browser 116, also when viewing a dimension matrix 124 or input screen etc. In one embodiment, the side panel charts tab provides configurable charts/graphs for an individual product/data line active on the associated screen or highlighted on the browser 116 or when viewing the dimension matrix 124 or the input screen or statistics console.

In one embodiment, the column/field tab 130 provides a sub tab for selecting the columns/fields on the associated screen. In one embodiment, the column/field tab 130 provides a sub tab for defining “Periods”; see FIG. 21(A) i.e. it duplicates an existing column/field while allowing the user to pre-set ‘from/to’ date ranges that apply to the data in the new column/field. In one embodiment, the side panel 122 may display a “Config.” sub tab 135 as shown in FIG. 21(A) and FIG. 21(B), 135 which list all the associated screens active filters, groupings, sequences etc. In one embodiment, the user may turn selective options/choices on or off via the “Config.” tab 135. In one embodiment, the user may have the option to save any configurable views/fields and to bookmark saved views/fields for recall later and/or to attach these to the menu system, the right click and/or the systems dashboard.

If the user moves from one data-line to other data-line, then data displayed on the side panel 122 may change interactively to show data for the then currently active/highlighted data-line. For example, if the user has selected to see a chart on the side panel 122 and then changes the highlighted product on the product browser, the side panel still displays a chart but now populated with data for the newly highlighted product. At any time, the user may also select to see alternative data within the side panel 122, for example, chart formats such as bar/pie charts or graphs plus select alternative data such as sales for the last 6 months, sales plus stock values, margins per week, etc. In one embodiment, the user may select one of the side panels other data display options, such as product pictures or user selected summary data.

DRILLDOWN: The floating Drilldown screen provides alternative details/granular perspective for any consolidated or expanded data line where the optimum layout for humans does not naturally fit into the Browsers columns data/format. An example of this is the drilldown from a consolidated or expanded product data line to show a two-dimensional size/colour/fit matrix layout for a product. This particular Drilldown screen is available from the product orientated browser and is a dynamically configurable x/y pivot table which displays user selected data types e.g. stock, sales, profit etc. and is referred to herein as a Dimension Matrix, see FIG. 11.

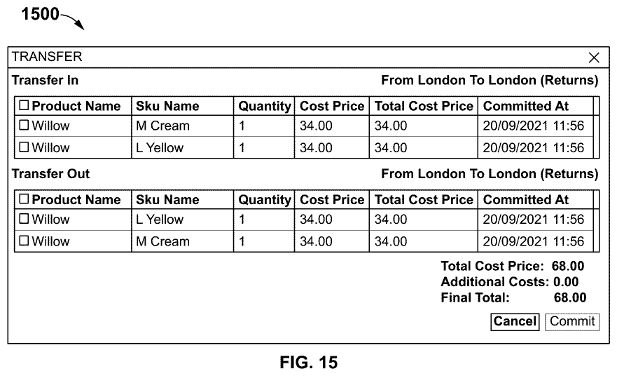

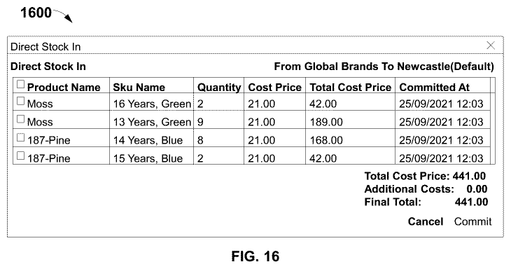

Within the browser 116, additional data may be accessed via the drill down window on each data line. The data exposed on a drill down window may be context sensitive and so varies depending upon the data orientation of the browser 116 and the type of data line the user is on. The browser drill down may provide a dimension matrix from the product orientated browser whereas if the browser 116 is transaction orientated, and the user drills down on a Direct Stock In line as shown in FIG. 6, the user may see granular details for goods received as shown in FIG. 16 illustrating an exemplary screenshot 1600 of the SMI 114 showing transactions-oriented drilldown to a Direct Stock In docket. If, however the user in Transactions (FIG. 6) is on a Transfer line in the browser 116, drill down allows the user to see the in/out transfer details as shown in FIG. 15 illustrating an exemplary screenshot 1500 of the SMI 114 showing transactions-oriented drilldown to an in/out transfer docket. In one embodiment, when the browser 116 is contacts orientated, the same action of drilling down on a data line may display a list of that customers purchase as shown in FIG. 17 illustrating an exemplary screenshot 1700 of the SMI 114 showing contacts-oriented drilldown to customer receipts docket. Drilldown options may be user configured, for example on the product orientated browser 116, the immediate drilldown option could be either a granular Expand-by list FIG. 22 or a Dimension Matrix FIG. 11, 124.

FIG. 11 illustrates an exemplary screenshot 1100 showing product-oriented drilldown to a multi-variant dimension matrix. In an embodiment, the dimension matrix 124 as shown in FIG. 11, provides data for one product at a time using a dynamically configurable x and y axis along the lines of a pivot table. For example, color (and/or fit) down the side and size along the top. The dimension matrix 124 is accessed via the product orientated browser using the drilldown option per data line of the browser 116. In one embodiment, the dimension matrix 124 has its own side panel 122, allowing the user to select multiple matrix data types such as stock, sales or order positions, sell through rates, profitability etc. Different data types may all be placed on one matrix, placed individually on separate matrix. or in any combination. The dimension matrix 124 capability is particularly useful for analysis of a product with a relatively large number of SKU variants (such as clothing/footwear and other examples would be mobile phones, chocolate bars, bedding, soft furnishing, luggage, pottery, eye glasses etc.).

The dimension matrix 124 allows for a comprehensive view of one products multiple SKC variants, all on the graphical user interface and with each of the matrix's vertical data columns and each of the matrix's horizontal data lines having totals and sub-totals displayed. Thereby allowing the user to understand the detailed multi SKC information far better per product than the same data in an expanded long list format.

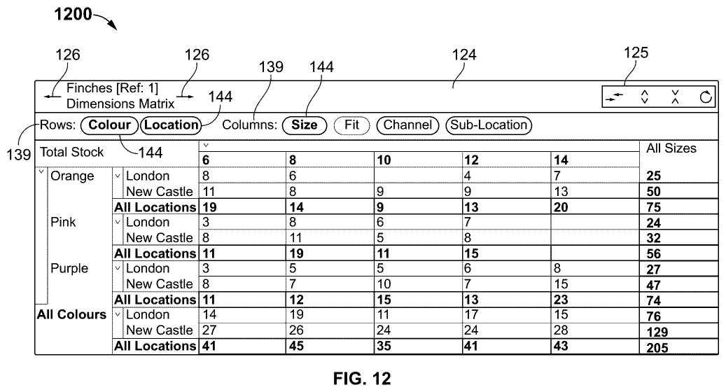

The dimension matrix 124 has a range of the pivot buttons, for example color, size, fit, location, channel, sub-location that allow the exact combination of the products SKC dimensions to be instantly defined. In one embodiment, these are either available or unavailable depending upon the dimensions that are relevant to each product, so if a product does not have a “fit” or “sub locations” then these will not be visible. In one embodiment, pivot buttons 144 may be activated or de-activated by the user clicking on them (i.e., turned on/off; de-activated buttons show as greyed out). For example, when ‘off’ a button 144 may be grey, when ‘on’ it may be bold or, say, purple; in FIG. 11 the “Location” pivot button is inactive (turned off), while “Colour” and “Size” are turned on/active. In one embodiment, the pivot buttons 144 may be dragged and dropped to re-position their data into either the rows or column categories 139 on the dimension matrix 124—in this way the user may define the x and y axis at will. FIG. 12 shows the Dimension Matrix for the same product (i.e. Finches) as FIG. 11 but in FIG. 12 the “Location” button has also been made active and as a result the SKC data for Finches in the matrix is now also broken down by location. So in one embodiment, every products dimensions/variants are completely granular at any level and in multiple ways. For the Dimension Matrix this is actioned using the on/off, and movable, pivot buttons while for the browser this is actioned by the Expand-by option choices. In both cases any variation of a products SKC dimensions may be combined at will including: Size, Colour, Fit, Location, Sub location and Channel—and for any data type and any time range. It is worth noting that products may also be viewed in what might be considered as a third, consolidated product, format—wherein all dimensions and data are combined into a one-line result as in FIG. 2.

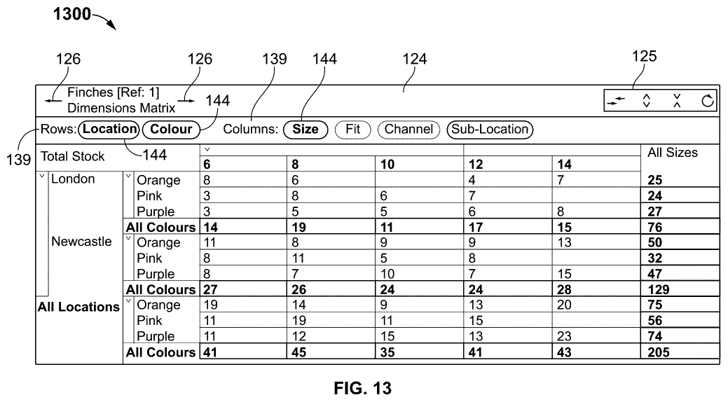

In one embodiment, data displayed in the dimension matrix 124 may be organized differently if the pivot buttons 144 are turned on/off and re-positioned relative to each other within either the rows or column categories, thereby defining and then re-defining the SKC. For example, as previously stated FIG. 12 illustrates an exemplary screenshot 1200 of the SMI 114 showing product-oriented drilldown to the multi-variant dimension matrix, representing first an active “Colour” and then second the “Location” pivot buttons within Rows and with only the “Size” pivot button active within Columns, according to an embodiment of the present invention. FIG. 13 however illustrates an exemplary screenshot 1300 of the SMI 114 showing the product-oriented drilldown to the multi-variant dimension matrix, alternatively representing first an active “Location” and then second the “Colour” pivot buttons within Rows and only “Size” pivot button active within columns, according to an embodiment of the present invention i.e. within Rows the Location and Colour buttons have been reversed between FIG. 12 and FIG. 13 and as a consequence the dimension matrix layout is altered. In one embodiment, the user may right click on one of the pivot buttons 144 to re-select its precise data type from a menu, for example, change the buttons function from (individual) “color” to “color group”. In one embodiment icons 125 for switch axis (i.e. move the user selected data from one axis to the other), expand matrix, and collapse matrix could be available along the top of a dimension matrix screen. In one embodiment, optional shortcut tabs to previously saved dimension matrix configurations and data content are available to the user from the side panel or above the matrix.

In one embodiment, using the navigation arrows 126 in the dimension matrix 124 as shown in FIG. 11 the user, while viewing the selected dimension matrix format 124, may move from product to product in the same sequence, group, filter as that then currently being applied to the browser 116. In one embodiment, this same capability using navigation arrows applies to drilldowns within any browser, regardless of its data orientation. In one embodiment the user may find specific products via various single or multiple lookup options such as name, description, department, type, etc. In one embodiment, the user has a ‘Quick Move, Quick Transfer, Quick Entry, Quick Receive’ etc. range of options directly into a Dimension Matrix or the product browser. This is a useful facility for smaller, ad hoc, stock or other movements of any sort or for products with few or no multiple variants, and since it makes immediate adjustments to the cells on the matrix or browser it is even quicker for making smaller additions/changes than the pre-define transaction options available via the right click. As appropriate, the facility also lets users invoke a window that offers the user several context sensitive options for such movements and/or to drag and drop stock, orders etc. between cells visible on the dimension matrix or browser; for example, specify the quantity being moved to another location etc.

In one embodiment, the user may use the side panel 122 (in exactly the same way they can with any browser) to select the dimension matrix 124 data types the user requires, such as sold quantity, sales value between dates, total stock, profit value, margin, orders, in transit, opening stock at a given date etc. of any product. In one embodiment, matrix fields could be allocated date ranges (periods) from within the side panel 122. In one embodiment, selected matrix data views may be saved by a save view button 147 and accessed at any time from the side panel 122. In one embodiment, the dimension matrix 124 may be floating above the browser 116. In one embodiment, the dimension matrix 124 may be docked beneath the browser 116.

INPUT SCREEN: Access to the input screen is available from the right click on the browser 118 or via a shortcut option, the Inputs screen provides a floating window for data input options relating to the Browsers highlighted data line. Examples of this are add/edit a customer, edit transactions, enter stock or transfers, print details/barcode labels etc. While inputting, the user can also simultaneously review any related decision-supporting data they need via the Inputs Screens Statistics Console e.g. FIG. 19, 154.

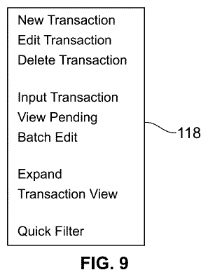

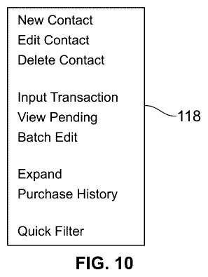

In one embodiment, the input window may be accessed by either a short cut option on the browser 116 or via the browser's right click as shown in FIG. 8 or 9 or 10. The input window may vary depending upon the data orientation of the browser 116 and/or the type of data line on the browser 116. In one embodiment, the user may use navigation keys to move from inputting one product to inputting a different product either, in the same sequence as the product browser (by using a navigation arrow 126 of the input screen FIG. 19, 150) or via various lookup options such as name, description, department etc. This capability is consistent across the Focus Screen for all data orientations. FIG. 5 illustrates an exemplary screenshot 500 of the SMI 114 showing contact data over the browser 116 and additional data of highlighted contacts over the side panel 122, according to an embodiment of the present invention. In an embodiment, where the browser data line is contact orientated, as in FIG. 5, then the right click as shown in FIG. 10 may display options for entering new customers, editing customer details, staff details, staff pass wording, staff clocking-in times etc. Where the data line is transaction orientated, as shown in FIG. 6, then the right-click options, as shown in FIG. 9, may cover edits to the data, the addition of new information, confirmation that actions have been completed etc.

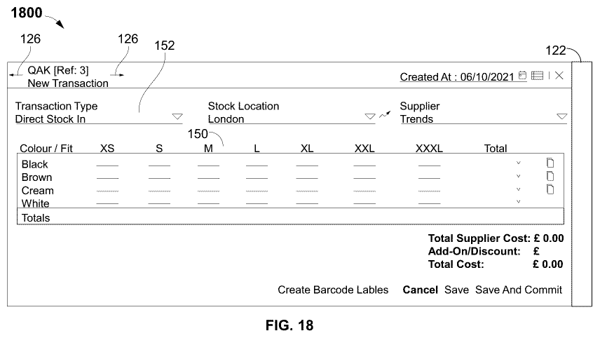

In one embodiment, entry for a multiple SKU product may be done via a blank input matrix window with size across the x axis and color/fit on the y axis, as shown in FIG. 18 illustrating an exemplary screenshot 1800 of the SMI 114 showing a blank input screen for a multi variant product. A single cell entry for products with only one or few SKU's is also available directly into the product browser itself FIG. 2. In one embodiment, the user via the right click or a short cut, may see the transfer, or any other input screen, for a selected color/fit across multiple locations. In this color/fit embodiment, for a multiple SKU product, for each color/fit the input matrix could show sizes along the x axis and locations and/or sub-locations down the y axis and, thereby facilitating inputs/transfers for many locations on the one input screen. If the user selects an alternative color/fit, then the screen data is refreshed as appropriate. In one embodiment, where the browser is product orientated the right click options may allow for the user to open a window to Input as shown in FIG. 18; once in the input screen by defining the type of transaction via a ‘transaction type’ picklist 152, as shown in FIG. 18; so enabling the user to record the entry of stock/adjustments/returns to supplier/purchase & sales orders etc. Input screen options for all data types are accessed in the same way regardless of the data orientation of the browser, while the format and data entry options themselves will be as appropriate to the type of data the user has selected to view in the browser.

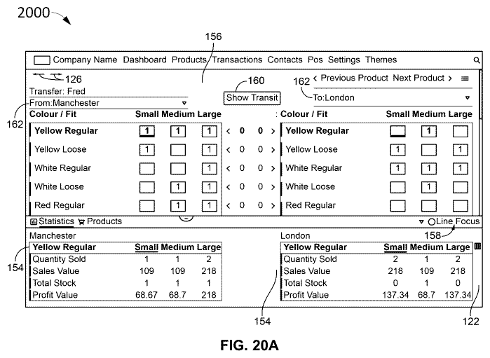

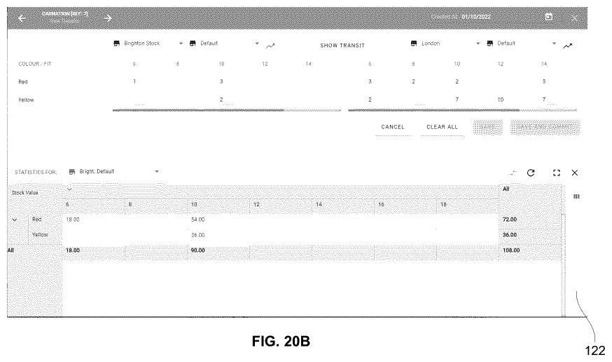

Ideally, transfer related entry screens require a minimum of two locations stock to be visible on the input screen FIG. 20(A), 156 and viewed simultaneously and where both “From” and “To” locations 162 may be defined by the user. FIG. 20(A) illustrating an exemplary screenshot 2000 of the SMI 114 showing transfer/move input screen for the multi variant product called “Fred” across multiple color/fits, with the statistics console mirroring the format of the input screen and showing user selected data for “Fred”. In one embodiment, alternative versions of the transfer input screen are also available with two or more simultaneous locations being viewed at the same time for a product. For example, a transfer input screen for one color/fit only so that sizes may be along the x axis and multiple locations/sub-locations down the y axis. In one embodiment, alternative versions of the transfer input screen are also available with two or more simultaneous locations being viewed at the same time and with a single statistics console displaying expanded interactive data for whichever of the products/locations the user is editing as shown in FIG. 20(B). In one embodiment, for transfers, the current stock positions at both the out-location (i.e., the location dispatching stock) and the in-location (i.e., the location receiving stock) is shown within the input screen FIG. 20(A). where transfers are shown as being from Manchester to London for a product called “Fred”. In one embodiment, an adjustment by the user to any cell in the Manchester “From” matrix automatically creates a balancing adjustment to stock numbers in the appropriate cell of the London “To” matrix, and vice versa—effected cells are highlighted for both (or multiple) locations so that the user may immediately see the consequences of their actions at both (or multiple) locations. In one embodiment, the user may enter positive or negative numbers into a cell within the matrix to indicate whether the stock is moving in or out of that location; balancing negative or positive numbers are automatically created at the other location. Similarly, the transfer input screen shown in FIG. 20(A)-20(B) provides a location bar where the user may enter an appropriate location (E.g. Brighton Stock) and in continuation with that, another location bar is provided where the user may enter an appropriate sub location (E.g. London), where the stock is to be received. Further, based upon the selected location and sub location, the updated stock value may be seen in real time presented to the user in FIG. 20(A)-20(B).

Note that within this same screen the user can select to transfer stock and/or change the status of stock between sub locations; changes to a products sub location are referred to by the inventor as a “Move” rather than a “Transfer” (e.g. “Move” from a location called ‘available to sell’ to a sub location called ‘return to supplier’). Using the “Input Transfer/Move” option FIG. 8, 118 in one action a user can transfer out of one location directly into a sub location at another branch or vice versa (e.g. from “Available to sell” at Shop A into the “Damaged Stock” area at Warehouse 1). Additionally, “Moves” can be made within the same physical location (e.g. Move the item from “Available to sell” at Shop A into “Return to supplier” at Shop A). In one embodiment, when doing a “Move” then FIGS. 20A and 20B might show the available to sell stock matrix on the left of the screen and show a “Return to supplier” matrix on the right (where FIG. 20A and FIG. 20B currently show an available to sell stock matrix for London).

The transfer input screen allows the movement of stock between Locations and Sub-locations; in every case the From/To options as shown in FIGS. 20A and 20B, offer the users a choice of both. For the SMI 114 the term “Locations” generally represents real-world places where stock may be held, for example, a store, a warehouse etc. Whereas “Sub locations” broadly track stock by their virtual status within a locating (although the exact usage will depend on how the user chooses to exploit the facility). For example, to move stock classified as active ‘stock’ into a sub location where stock is classified as ‘damaged’; or stock classified as ‘laid-away; or use sub locations to record where stock is located within warehouses bin locations; or merchandising tracked by where it is positioned on the shop floor etc. Therefore FIGS. 20A and 20B, may be either ‘From/to Locations’; or ‘From/To Sub Locations’ or a mixture of Location to Sub Location, or vice versa.

In one embodiment, the total of goods that are actually being moved between the two locations (in either direction) may be seen as a summary within the minimized “Show Transit” column FIG. 20A, 160,—whereas if “Show Transit” is maximized then a full matrix displaying all SKU's may be seen for all the Transit goods (i.e., the goods that need to be moved to achieve the position shown within the “From” and the “To” matrix displays). In one embodiment, the user may enter numbers into the maximized “Show Transit” matrix display, and this will create out/in transfers between the two locations being displayed on the transfer screen. In one embodiment the optional transfer/move option on the product browsers right click is used to “Transfer” the selected products SKU's between real world stock locations using just the browser. In one embodiment the optional transfer/move option on the product browser right click is used to “Move” the selected products SKU's between sub-locations (i.e. a real or virtual location within a physical shop/warehouse location) e.g. move from “Main Shop Free-to-Sell” to “Damaged”; or move from “Damaged” to “To be returned to Supplier”; or from warehouse/shop shelving area 0001 to warehouse/shop shelving area 0002; or from available to sell stock at location B into damaged stock at location A. In one embodiment, the transfer screen can be used to plan/track the conversion of one product into another; for example, to take a blank shirt product and add an embroidered logo so that the shirt is now a different product bespoke to a particular business or school (the blank product might be shown on the left of the transfer screen and the embroidered product on the right).

Data entry however is not a ‘by rote’ option for certain types of tasks. In particular, data entry for transfers and purchase orders needs to be based on historical performance for the type of product, the products price point, the locations involved etc. This key decision supporting historical data is traditionally only available via a separate reporting module(s). Consequently, while working out their transfers and/or purchases etc. the users of traditional systems need to pre-print the two or three separate reports they need per product in order to understand the product, or type of products, historical performance (and simultaneously for all a products variant overall, not just one variant at a time, and also in the appropriate format). For Focus Screen users however the decision supporting data is simultaneously visible. If making a single cell product entry/edit into a browser column, the user's own choice of decision supporting data is available on the browser, as shown in FIG. 2. For multi variant products being entered into a matrix format, the browser drill down via SMI 114, as shown in FIG. 1, provides both the input matrix 150, as shown in an exemplary screenshot 1900 in FIG. 19 and on the same screen the optional statistics console 154, as shown in FIG. 19. In one embodiment, the statistics console 154 may be automatically structured so that it mirrors the x/y axis format of the input matrix 150 above, so making it easy for the user to cross reference their inputs against the historical and current data they have selected to see on the statistics console, selected via the consoles side panel 122 FIG. 19 (shown minimized), e.g., for the relevant product, the statistics console will display stock position, sales, orders, sell through rates, profitability margins etc. The data itself may be dynamically selected by the user for the product they are on or, for a consolidated statistic console view, pulling together data from one or more similar products. Data choices are usually displayed along the y axis while size may be typically displayed horizontally across the screen (the x axis) as in the current standard presentation mode, however, it is contemplated by the inventor that these are interchangeable throughout the system and different product types may require different approaches.

In one embodiment the statistics console 154, as shown in FIG. 20A is shown in “Line Focus” mode 158, as shown in FIG. 20A, i.e., where data in the Statistics Console is limited to data for the line the user is on within the input screen 156. FIG. 20A shows a Transfer/Move input screen 156 for a multi variant product with the user entering transfers for Yellow Regular on the input screen 156—consequently, as the “Line Focus” is active, the data displayed in the statistics console 154 is only for the color/fit “Yellow Regular”. As long as “Line Focus” mode 158 remains active, if the user moves to a different line within the input screen 156 the Statistics Consoles data will change to show data for just that ‘new’ input line. This enables the user to quickly see a larger selection of the data they need at any moment and on the one screen, without the data from other input lines being visible and taking up screen space. Note that Statistics Console format and data can change in line with the input screen format as the user moves from product to product and between input types. Optionally, with Line Focus inactive, the statistics console may display extended data e.g. data for all colours/fits regardless of the actual line the user is editing at any one moment.

CONCLUSION: All the key elements within the Focus Screen are linked together into a consistent and cohesive whole; supporting, complementing and interacting with each other. For example, if on the Browser the user is filtering/sequencing/grouping using one or multiple column headings, the side panel always displays appropriate data or images or charts for each line. If the user chooses to Expand, Drilldown or Input data they can use the navigation arrows within each of these options to move forward or backwards in the same order as the filtered/sequenced/grouped data lines on the Browser (whether it be displaying products or transactions or customers)—and at the same time the side panel (with its consistent UI) within each of these options is also changing the data it displays as appropriate as users move between the data lines. In one embodiment the single Focus Screen (SMI, 114) also enables any user to access their variant product data system-wide in any of three interactive configurable formats as appropriate (as consolidated product's, expanded and dimension matrix) whereas conventional systems only have one system-wide, non-configurable, product format (i.e. a fully expanded product list). Further the exact combination of a products dimensions can also be easily and instantly re-configured to display any SKC combination the user may require. This constant system-wide availability of multiple focus screen formats to view and understand multiple or single products in any formulation of stock keeping composite is just not available in conventional systems.

In one embodiment, the reader can see that the Focus Screen allows a system user to input and manage every aspect of their hub stock management system across multiple data types and from within a single screen interface, with far more uniformity and power than systems structured along traditional lines. Further the web-based inventory management system SMI 114 also provides at least three ways to display information for a product and that each way is also highly configurable i.e. “as a consolidated product”, “as an expanded list” and “as a matrix”.

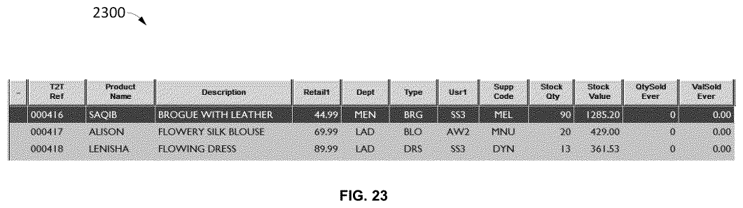

FIG. 23 illustrates an exemplary screenshot 2300 presenting product details for “Saqib”, “Alison” and “Lenisha”. Herein, the products “Saqib”, “Alison” and “Lenisha” may each be seen as a consolidated product with details such as Description, Retail 1 (main retail selling price), overall stock quantity, overall sales value etc.—but without the ‘clutter’ of details for the individual SKU's within each product. Being displayed as consolidated, whole, products makes it far easier for a user to compare/assess products against each other (note that the product “Alison” overall has a total of 20 items in stock).

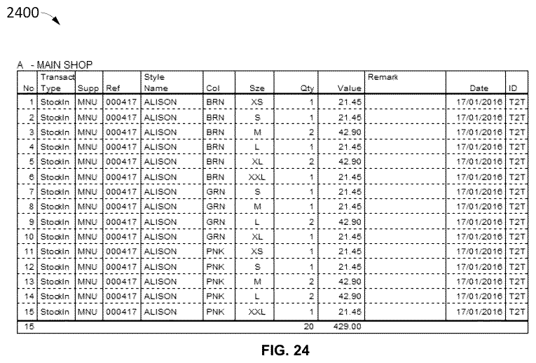

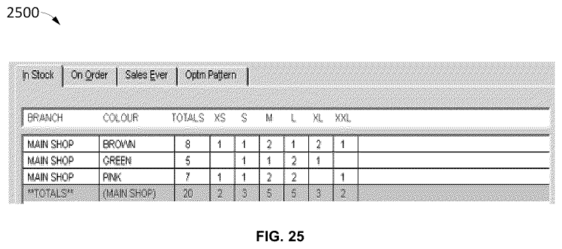

Further, FIG. 24 illustrates an exemplary screenshot 2400 of product “Alison” as an expanded list of stock keeping units (SKU's). Herein, the SKU elements such as style name, colour, size, quantity etc. are displayed individually per SKU in the full expanded/list format; it can still be seen that “Alison” has the same 20 items of total stock. Further, FIG. 25 illustrates an exemplary screenshot 2500 of product “Alison” showing the individual SKU's but in a matrix format; again, note that the product “Alison” has the same 20 items of total stock.

Within the Focus Screen (FIG. 1, SMI 114) each of these three (i.e. consolidated, expanded, matrix) flexible product formats has innovative stock management related configuration capabilities to create SKC's—whereas traditional stock management systems can only offer, at best, system-wide and interactive access to detailed data in just one fixed format. The traditional system's single fixed format is the Focus Screens equivalent of a fully expanded SKU product list (i.e. a product expanded by all of its dimensions—size/colour/fit etc. sometimes not including locations etc.), but without the Focus Screens SKC capability of combining only the dimensions that the system user wishes to select in order to instantly make SKC's—including optional locations, channels, sub-locations etc. (available in both the browser and also the dimension matrix formats).

The benefits of the new approach are dramatic, as the following example makes clear. FIG. 24, displays Alison in the same way as would be the case in a conventional system, Alison is 15 full SKU lines across the screen (a line per product for every colour and size combination that Alison comes in), plus the focus screen can provide a totals line per style regardless of the number of styles in a list (conventional systems, when listing multiple products, do not provide this). In a conventional system the only way interactive data lines are available is as fully expanded SKU lines; so if the user wants to assess Alison for each of its colours, then they must always deal with 15 lines of data. The conventional system user could either add each of a colour's lines together manually (in their heads or with a calculator etc.+pen and paper to note the results) or, if their conventional system offers a filter/reporting facility somewhere via its menu system, then perhaps filter first to see the lines that are BRN (brown) and note the total, then filter to see all the lines that are GRN (green) and note the total and then filter to see all the lines that are PNK (pink) and note the total. Alternatively, a conventional system may access this data a different way, but whichever interactive way the conventional system displays its results (aside from its limited reporting module/s), it is always as a format involving 15 lines of product/size/colour data (a conventional system may have a non-interactive, one-off, broadly fixed report in its separate reporting module(s), which just happens to cover the particular breakdown the user needs, and also for the particular combination of data fields the user requires—although a good match to the users requirement is in fact unlikely, as there are potentially millions of such combinations). With the focus screens facilities however, SMI 114 can be interactively configured to display any selective combination of SKU dimensions (i.e. SKC's) for the users dynamically selected data—with just a few clicks the user can create any one of the millions of possible permutations of SKC they may want. For example, the focus screen user could simply start with the single consolidated line for Alison and then expand it by colour—and so get just three lines for Alison (rather than the conventional systems 15 lines); a single line for all the BRN (brown), a single line for all the GRN (green) and a single line for all the PNK (pink), plus relevant total(s). Using the focus screen the user can do this for just one product or simultaneously for any number of products on the focus screen browser. Similarly, in a dimension matrix (FIG. 12, 124), the stock keeping composite (SKC) capability is achieved by turning the movable pivot buttons on/off. e.g. FIG. 11 displays data for SKC's by colour and size; the product, “Finches”, does have fits but these are not being broken out from within the colour/sizes combination.

It should be noted that simultaneously to users selecting the products(s) stock keeping composite (SKC), the user can also select any data columns or matrix fields they wish—as well as use filters, sequences and groups. So, the SKC configuration they have selected is automatically available for the vast range of stock management data, filters, sequences and groups the focus screen simultaneously makes available on the browser and matrix per SKC line/field (e.g. for stock value, sales, margin, sell through, profit etc.). To those skilled in the art it will be obvious that, say, if there were a hundred products like Alison (for convenience let's say that they all have the same three colours) the focus screen can be easily configured to show just three colour lines (each of which has the users' choice of data and each of which is the complete summary for each colour across all the 100 products), plus a total. Note that this is achieved on the browser with only three/four clicks: expand by colour, then group by colour, then display summary lines only. A conventional system however has no interactive SKC capability/concept, nor simultaneous data selection with optional filters, sequences and groups—so instead of the focus screens three lines plus a total, a conventional systems interactive display would overall show 1,500 lines (i.e. 100 products each with 15 SKU's) plus maybe totals.

When focusing on one product however the dimension matrix is the easiest way for a human to assess the performance of any one multi variant product, since its two-dimensional format and totals for both rows and columns makes that products granular data instantly understandable. Alternatively, the expanded list view allows users to assess data across multiple products in order to answer questions such as “How many white shirts do I have across my whole business?” (regardless of sizes, locations etc.), “How many of them are size XL?”, “How many are there at my discount shop(s)?” In a conventional system the interactive system-wide format would display thousands or tens of thousands of SKU lines which the user would be required to go through row after row over many screen pages i.e. similar to FIG. 24 but instead of for just one product (Alison), for hundreds or thousands of products each with maybe 1-40 lines/variants). Note that there would be no totals etc. to indicate visually where the separate variants for one product ended and another set of variants for a different product began. Conventional systems may have some filtering capability, although this is usually via separate reporting areas/module(s) of the system, but they are nearly always filtering the full SKU lines (so will not really give the user what they actually need, it will have a lot more lines than the user really wants, many of which may need to be manually added together (or ignored) before the user can get at the particular combination of dimensions they actually need). There is no conventional system option/concept to create flexible, interactive, user selected SKC's or to interact with a similarly flexible dimension matrix format.

So in developing the focus screen concept a number of new linguistic terms were needed to parallel the innovation within the invention, with particular reference to introducing a greater degree of comprehensibility and precision regarding how the real-world components/elements within a product are reported on and described. Within the stock management industry generally, terms are used somewhat loosely and the same term can apply to different things (e.g. till/EPOS can apply to hardware, or software, or both together). The only real precision in the area of product definition is around the term SKU—Stock Keeping Unit. An SKU is the lowest level of definition a product can be (for example a specific product in one size, one colour and one fit). The elements with an SKU are defined by real-world reality—if an item has just a size and a colour (no fit) then its SKU defines a product/size/colour, whereas if it has a size, a colour and also a fit then its SKU has to define a product/size/colour/fit—it's a rigid real-world mapping. As well as SKU, terms such as “product” and “item” are also used—but within sectors managing multi-variant products these are used interchangeably to refer to both an individual SKU or alternatively, the combination of SKUs that usually form the totality of a single multi-variant product. Within clothing/footwear the word “style” has a greater degree of precision but cannot be used to apply to all the other sectors that the focus screen can be used in.

Given the vastly extended flexibility of the focus screen therefore, the limits of SKU terminology are inadequate for describing the focus screens functions and capabilities. The significant innovation here is the term SKC−Stock Keeping Composite, which includes all the same elements as an SKU+also locations, sales channels and sub-locations (stock at locations/sub locations can of course be changed at will by a user). Conventionally the term “composite” is sometimes used, by itself, to denote a multipack of different SKU's e.g. a football kit comprised of shirts, shorts and socks or for a multi pack of three pairs of socks, but this is completely different to an SKC wherein the dimensions included within the stock, sales, orders etc. for a single overall product are re-defined at will by the user.

In particular, the innovation lies in the fact that combinations within an SKC are entirely at the users' behest, elements may be included, excluded or combined within the composite (SKC) and the sequence within that can also be user defined; consequently, SKC's are completely user defined and composed of flexible, interchangeable and optional, user selected elements. This SKC definition reflects retailers' requirements for the wide variety of cross cutting product analysis which the focus screen now makes available. So whereas an SKU clearly exists in the real world, an SKC is a very useful analysis/virtual concept that may or may not have an exact expression in reality. For example, an item with multiple colours and sizes can be expressed as a virtual SKC that uses the colours only—so that the sizes (which of course exist in the real world) are ‘ignored’ and subsumed within each product/colour SKC reported on and the sizes are not individually visible.

This flexibility, to instantly and at any time create virtual SKC products, is very useful for a retailer dealing with single variant, but especially multi-variant, products. For example, in the case of a clothing/footwear retailer trying to analyse what is their bestselling colour—because the retailers' whole decision process would be far longer and more difficult if every colour was also broken down into multiple sizes since, in this limited case, sizes do not contribute in any way to the colour analysis the retailer is attempting. The same may be true if the retailer wishes to analysis good/poor performers based on sizes only (they may want, at least initially, to ‘ignore’ colours); or the retailer may wish to focus on locations only (and initially ‘ignore’ both size and colour). The endless and multiple SKC combinations made available by the focus screen innovation are an exceptionally powerful new retail tool, and as a new capability it is very helpful to have a new word/concept to define it. It is indeed noteworthy, that until now there has been no word (and no need) in the language for all the possible real-world combinations/elements that define a product. Historically stock management system reports may have made a particular, fixed, SKC combination available, by necessity in a very limited number of cases (e.g. a broadly fixed format colour report), but until now there has never been a comprehensive, flexible user capability to self-generate/define any required SKC, and all its user selected data, on demand.

Within the focus screen the availability and richness of the extensive SKC definition options play themselves out within the browsers “Expand” option and similarly, for products only, within the “Dimension Matrix”; which are both, in essence, different formats for seeing SKC's—as defined and re-defined instantly and interactively by the focus screen user. Using clothing/footwear as an example, the minimalistic extreme is where all sizes, colours, fits, locations, sub locations, sales channels etc. for a product are compressed into one number for stock, one number for sales, one number for orders etc. and we have defined this extreme as a “consolidated product”. This is still technically a SKC, but it is a useful term as it clearly defines one end of the SKC spectrum; there is no smaller, more concise, way of expressing the product stock, sales, order etc. information than when referred to as “consolidated”. At the other product extreme is the full Expanded product or full Dimension Matrix—where all real-world elements, including location/sub location etc., are visible (i.e. all possible SKC components within a product are being displayed). In the middle of these extremes is the vast number of SKC options and combinations that are expressed via the flexibility of the Focus Screen.

From the above it is clear that an efficient inventory system should allow the user to both see their different data types (product. transactions, contacts) within a single, clear and highly flexible interactive user interface as well as having the ability to switch between viewing product granularity in the three ways that are required at various junctures within the stock management process (i.e. consolidated, expanded, matrix). Conventional systems however are trapped within their multiple screens functional approach, wherein each screen may be different to every other and with just a single, fixed, fully SKU based, data structure i.e. an always fully expanded list. Across their many screens they do not provide even one configurable, interactive SKC format, much less all three configurable formats within a single configurable interface, which also accommodates inputs, edits, filtering, sequencing, grouping etc. and which works across all data types. This combination of all the key essential features within just the one focus screen interface is a novel and original invention.

In one additional embodiment, the focus screen may also be configured into a reporting only version. In this version stock, sales, orders etc. may be imported on a regular live/hourly/daily basis from much bigger stock management systems and the Focus Screen (exactly as it is described herein) may be used only as a convenient and flexible reporting/analysis tool.

The foregoing description comprises illustrative embodiments of the present invention. Having thus described exemplary embodiments of the present invention, it should be noted by those skilled in the art that the disclosures within are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

### LIST OF ELEMENTS

100 Web-based inventory management system
102 Computing device
104 Processor
106 Memory
108 Server
110 Network
112 Database
114 Stock Management Interface (SMI)
200 Screenshot
116 Browser
118 Right click option
122 Side panel
124 Dimension matrix
125 Dimension matrix screen
126 Navigation arrows
128 Info tab
130 Column field tab
132 Chart tab
133 Useful tools
134 Vertical data columns
135 Config. sub tab
136 Expand by option
137 Dot menu
138 Filter
139 Column categories
140 Icon
141 Data lines
142 Column totals
143 “Group by” bar
144 Pivot buttons
145 Total possible lines
146 Sub totals
147 Save view button
148 Icons
149 Sequence option
150 Input matrix
152 ‘transaction type’ picklist
154 Statistics console
156 Input screen
158 “Line Focus” mode
160 “Show Transit” column
162 “From” and “To” locations
300 screenshot
400 screenshot
500 screenshot
600 screenshot
1100 screenshot
1200 screenshot
1300 screenshot
1400 screenshot
1500 screenshot
1600 screenshot
1700 screenshot
1800 screenshot
1900 screenshot
2000 screenshot
2100 screenshot
2200 screenshot
2300 screenshot
2400 screenshot
2500 screenshot

What is claimed is:

1. A locally based or web-based inventory management system comprising:
a computing device having a processor coupled to a memory, and communicatively coupled to a server over a network interface, wherein the memory comprises a set of instructions executed by the server, and wherein the computing device having:
a stock management interface (SMI) in communication with the processor and configured to provide fast or near instant responses to any update, data selection, filter or data configuration the user requires, the SMI is a multi-user hub system configured with a single screen interface that is standard across all appropriate stock management functions and data types, wherein the single screen interface is user configurable and comprised of four standard and consistent components, these being a browser, a side panel, a drilldown and an input screen;
a database coupled to the server, and configured to store data related to one or more activities of a supply chain management environment including shops, in-transit, storage and manufacturing areas, web sites and third party links, for all aspects of data relating to supply chain management, including stock, retail/wholesale, web site, warehouse management, sales, sales orders and purchase orders, customers and their details/histories, wherein the database comprises one or more program modules to be executed by the server to:
handle products with one or more stock-keeping units (SKUs) with respect to the one or more activities; and
enable one or more users to undertake all stock management related activities by interacting within the single screen interface using the four configurable components of which it is comprised.

2. The web-based inventory management system of claim 1, wherein the SMI corresponds to a common focus screen to display the data related to the one or more activities at a time via the browser, the side panel, the input screen, and the drilldown.

3. The web-based inventory management system of claim 1, wherein the focus screen corresponds to a touch screen and/or a non-touch screen adapted to run on any type of operating system (OS) such as iOS, Windows, Android, Unix, Linux, and/or others.

4. The web-based inventory management system of claim 1, wherein the one or more activities include product details, stock details, sales details, order details, and customer details, for data of all types such as quantity/value/currency/percentages and relating to both real world and virtual locations/channels.

5. The web-based inventory management system of claim 1, wherein the browser is configured to retrieve information requested by a user.

6. The web-based inventory management system of claim 1, wherein the side panel is configured to provide supporting data for the actions performed by the user on the browser.

7. The web-based inventory management system of claim 1, wherein the input screen is configured to receive instruction inputs given by the user regarding the data of the one or more activities as represented over the browser.

8. The web-based inventory management system of claim 1, wherein the drilldown is configured to represent and access context specific data in conjunction with the data represented over the browser.

9. A web-based inventory management system comprising:
a computing device having a processor coupled to a memory, and communicatively coupled to a server over a network interface, wherein the memory comprises a set of instructions executed by the server, and wherein the computing device having:
a stock management interface (SMI) in communication with the processor and configured with a single screen interface that is standard across all appropriate stock management functions and data types, wherein the single screen interface is user configurable and comprised of four standard and consistent components, these being the browser, the side panel, the drilldown and the input screen;
a database coupled to the server, and configured to store data related to one or more activities of a supply chain management environment, wherein the database comprises one or more program modules to be executed by the server to:
handle products with one or more stock-keeping units (SKUs) with respect to the one or more activities;
enable one or more users to undertake all stock management related activities by interacting within the single screen interface using the four configurable components of which it is comprised;
enable one or more data entries onto the browser using a right click option for the one or more activities, wherein the one or more data entries comprises data changes such as product/transaction/customer, creation/editing/deletion, including batch editing of multiple products, stock receipt, supplier returns, transfers, sales orders, purchase orders, and sales;
enable one or more data views optionally using the right click, such as expand, drilldown etc. including invoking windows to view a multiplicity of data configurations and windows to view transactions such as sales, transfers, delivery, order dockets, customer purchases;
selecting and positioning of multiple columns on the browser via the side panel using multiple tick boxes and/or drag and drop options;
creating columns with from/to dates via the side panel;
use one or more column headings to sequence data within the single screen interface and/or to group data within the single screen interface;
applying options to define the granularity of all user data for one or more browser rows and/or matrix views, such as size, colour, fit, location, sub location channel etc. so the user can define his own combination of Stock Keeping Composite (SKC) elements at will.
applying filters to each of the multiple columns to display data of the selected columns over the browser and representing the filtered items as a display of data rows/columns or as a chart/graph; and
provide on screen browser totals, sub-totals, sub sub-totals etc., for all user selected browser rows/columns configurations.

10. The web-based inventory management system of claim 9, wherein the browser is configured to retrieve information related to the one or more activities with respect to an input received from a user.

11. The web-based inventory management system of claim 9, wherein the side panel is configured to provide supporting data for the actions performed by a user on the browser.

12. The web-based inventory management system of claim 9, wherein the drilldown is configured to represent and access a context specific data in conjunction to the data represented over the browser.

13. The web-based inventory management system of claim 9, wherein the input screen is configured to receive instruction inputs given by the user regarding the data of the one or more activities as represented over the browser.

14. The web-based inventory management system of claim 9, wherein the one or more activities include entries such as product details, stock details, order details, sale values, currencies, customer details, customer purchase details, staff details and performance measures such as profit, values, and margins for one or more inventories.

15. The web-based inventory management system of claim 9, wherein the one or more data entries are automatically saved within the database periodically.

16. The web-based inventory management system of claim 9, wherein the browser enables sequencing and grouping of the one or more activities within each of the selected columns.

17. The web-based inventory management system of claim 9, wherein the browser options or side panel enables expansion or breaking of data lines on the browser into one or more combinations of elements for one or more parameters for each product e.g., colour, size, fit, location, and sub location broken down into multiple data lines per unit across all user selected column data on the browser.

18. The web-based inventory management system of claim 17, wherein the one or more program modules enable adjustment of the one or more parameters of the one or more inventories on a matrix display using the drilldown to a dimension matrix, to a multidimensional view of a product.

19. The web-based inventory management system of claim 17, wherein the one or more parameters include colour, size, fit, location, channel, and sub-location of the one or more inventories.

20. The web-based inventory management system of claim 9, wherein the one or more program modules enable linking optional views on the side panel to each highlighted item on the browser.

21. The web-based inventory management system of claim 9, wherein the one or more program modules provide a hub system to enable extra data entry options for an e-commerce website.

22. The web-based inventory management system of claim 21, wherein the hub system is configured to provide a facility to enter/generate optimum patterns, monitor stock levels, and generate purchase orders and transfers automatically, and allowing a user to update/refresh data and export/import data.

23. The web-based inventory management system of claim 9, wherein the focus screen corresponds to a touch screen and/or a non-touch screen adapted to run on any type of operating system (OS) such as iOS, Windows, Android, Unix, Linux, and/or others.

24. The web-based inventory management system of claim 9, wherein the database is stored with separate data tables for each of the one or more activities.

25. The web-based inventory management system of claim 9, wherein the browser panel represents information to the user in at least three ways i.e., as a whole product, as a list and as a matrix.

26. The web-based inventory management system of claim 9, wherein the server executes a mapping process to:
determine a target data table based at least upon user requirements;
fetch only essential information from the target data table for the one or more activities; and
generate one or more reports by reshaping the fetched essential information into the SMI between the browser, the side panel, the drilldown, and the input screen.

27. The web-based inventory management system of claim 26, where the one or more reports generated by the server is presented to the user by the processor.

28. The web-based inventory management system of claim 26, wherein the user requirements include at least one of accessing and/or updating customer details, inventory details, tracking and managing stocks, sale and purchase of stocks, or stock details.

29. A non-transitory computer readable medium having one or more program modules for storing instructions executed by a server communicatively coupled over a network interface, wherein the one or more program modules are executed by the server to:
handle one or more stock-keeping units (SKUs) with respect to one or more activities;
enable navigation between a plurality of screen views by interacting within a single screen interface, wherein the plurality of screen views comprises a browser, a side panel, an input screen, and a drilldown; and
enable one or more data entries onto the browser using a right click option for the one or more activities, wherein the one or more data entries related to the browser comprises:
selecting and positioning of multiple columns on the browser via the side panel using drag and/or drop options; and
applying filters to each of the multiple columns to display data of the selected columns over the browser and representing the filtered items as a display of data columns or as a chart/graph.
